(19) United States
(12) Patent Application Publication
(10) Pub. No.: US 2008/0041026 A1
(43) Pub. Date: Feb. 21, 2008

(54) Air cleaner assembly; components; and, methods

(76) Inventors: Donald Francis Engel, Prior Lake, MN (US); Bradley A. Kuempel, Eden Prairie, MN (US)

Correspondence Address: MERCHANT & GOULD PC, P.O. BOX 2903, MINNEAPOLIS, MN, 55402-0903, US

(21) Appl. No.: 11/893,197

(22) Filed: Aug. 15, 2007

Related U.S. Application Data
(60) Provisional application No. 60/848,593, filed on Sep. 29, 2006.
(60) Provisional application No. 60/838,560, filed on Aug. 18, 2006.

(51) Int. Cl. B01D 29/15

(52) U.S. Cl. 55/432

(57) ABSTRACT

An air cleaner assembly and components therefor are described. One of the components characterized is a filter cartridge including a first end cap with an outwardly directed pinch seal flange on an end cap at one end of the cartridge; and, an opposite end with a housing seal. An example air cleaner housing is described, for sealingly receiving the filter cartridge therein, during use. Methods of assembly and use are also described.

### CROSS-REFERENCE TO RELATED US PROVISIONAL APPLICATION

Certain techniques described in the present application relate to those described in U.S. Provisional Application 60/838,560 filed Aug. 18, 2006. The complete disclosure of U.S. Provisional Application 60/838,560 is incorporated herein by reference.

### FIELD OF THE DISCLOSURE

The present disclosure relates to air cleaner assemblies, to components therefor and to methods of use. The air cleaner assemblies are particularly adapted for utilization mounted on an exterior of a cab of a vehicle, such as a truck. The air cleaner is configured for operation with an in-to-out filtering flow through a serviceable air filter cartridge, during filtering operation.

### BACKGROUND

A wide variety of air cleaner arrangements are known. Many are utilized for filtering engine intake air for vehicles and other equipment such as trucks. Typically the air cleaner includes a housing with a removable access cover; and, a removable and replaceable (i.e., serviceable) filter cartridge positioned within the air cleaner housing. After a period of use, the serviceable filter cartridge is typically sufficiently loaded with dust, so as to require servicing. This is typically done by: removing the access cover; removing the filter cartridge from the air cleaner assembly; and, providing a “new” filter cartridge in the air cleaner, for further use. The “new” air cleaner cartridge, may comprise: a factory, previously unused, filter cartridge; a previously used, but refurbished, filter cartridge; or, the filter cartridge previously removed but then serviced and reinstalled. Herein, without specific regard to which of these three possibilities (or alternates) is practiced, unless otherwise identified the cartridge installed during servicing will be referred to as the “new” filter cartridge.

Certain air cleaner arrangements are configured for “in-to-out” flow of air through the serviceable air filter cartridge, during filtering. Some examples are described in U.S. Pat. Nos. 5,613,992; 5,690,712; 5,938,804; 5,897,676; 6,004,366; 6,258,145; 6,322,502; 6,413,289; and, 6,521,009, each of which is incorporated herein by reference.

A typical “in-to-out” flow air filter cartridge of the type described in these patents, includes an extension of media surrounding an open central volume and extending between first and second end caps. The first end cap is configured with a central aperture for passage therethrough of inlet air to be filtered. The inlet air is then directed from the inside of the filter cartridge to the outside, with filtering as the air passes through the media. This arrangement traps dust and other material (loaded onto the media) inside of the region surrounded by the filter media. The second end cap can be provided with a drain aperture, to facilitate draining of any water (rain water for example) that may pass into the interior of the filter cartridge, during operation.

Improvements in filter cartridge construction and alternate installation are sought.

### SUMMARY OF THE DISCLOSURE

According to the present disclosure air cleaner assemblies and components therefor are provided. The air cleaner assemblies typically include a removable and replaceable (i.e., serviceable) air filter cartridge. The air filter cartridge generally comprises a media pack extending between first and second end caps. The first end cap includes a central air flow aperture and an outwardly directed pinch seal flange arrangement thereon, the pinch seal arrangement extending radially outwardly away from the media pack in a direction also away from the second end cap. The second end cap typically includes a housing seal portion thereon and a drain arrangement. The housing seal portion of the second end cap is typically an outwardly directed radial seal portion.

Specific advantageous features are shown and described.

Also described are air cleaner arrangements, for example including a filter cartridge as described. The air cleaner arrangement typically includes a housing having: an air flow inlet; an air flow outlet; and, a filter cartridge receiving base with a liquid drain arrangement therein. A seal support is positioned on the filter cartridge receiving base; the seal support including an open central aperture through which the cartridge can project when installed. A seal plate assembly is mounted in the air cleaner to pinch the pinch seal flange on the cartridge to form a seal between the seal plate assembly and the seal support.

Methods of assembly and use are also described.

There is no specific requirement that a construction include all of the features characterized herein, in order to obtain some advantage according to the present disclosure.

### BRIEF DESCRIPTION OF THE DRAWINGS

FIG. 1 is a schematic side elevational view of an air cleaner assembly according to the present disclosure.

FIG. 2 is an enlarged, schematic, top plan view of the air cleaner assembly depicted in FIG. 1.

FIG. 3 is an enlarged schematic top plan view of the air cleaner assembly depicted in FIG. 1, with an inlet/access cover assembly and seal plate assembly removed.

FIG. 4 is a schematic cross-sectional view taken along line 4-4, FIG. 2.

FIG. 5 is a schematic cross-sectional view taken along line 5-5, FIG. 2.

FIG. 6 is an enlarged, schematic, top perspective view of a filter cartridge for installation of air cleaner of FIGS. 1-5.

FIG. 7 is a schematic cross-sectional view of the filter cartridge of FIG. 6, taken along line 7-7, FIG. 6.

FIG. 8 is a schematic view analogous to FIG. 4 but depicting the air cleaner assembly with an inlet/access cover assembly including a seal plate assembly removed.

FIG. 9 is an enlarged, schematic, fragmentary view of a first, upper, portion of FIG. 8.

FIG. 10 is an enlarged, schematic, fragmentary view of a second, bottom, portion of FIG. 8.

FIG. 11 is a schematic, exploded, perspective view of selected portions of air cleaner assembly of FIG. 1; FIG. 11 depicting a step of servicing.

FIG. 12 is a fragmentary, schematic, exploded, perspective view of selected portions of the air cleaner assembly of FIG. 1 and showing selected internal structure.

FIG. 13 is a schematic, exploded, top perspective view of the air cleaner assembly of FIG. 1.

FIG. 14 is a fragmentary, schematic, exploded view of selected componentry depicted in FIG. 12.

FIG. 15 is a schematic, enlarged, fragmentary view of a first portion of FIG. 4.

FIG. 16 is a schematic, enlarged, fragmentary view of a first portion of FIG. 5.

FIG. 17 is an enlarged, fragmentary, schematic view of a first, pinch seal portion of FIG. 7.

FIG. 18 is an enlarged, fragmentary, cross-sectional view of a second, annular, seal portion of FIG. 7.

FIG. 19 is a bottom perspective view of the filter cartridge of FIG. 6.

FIG. 20 is an exploded view depicting the assembly of FIG. 11, with portions reoriented to facilitate viewing of selected features.

FIG. 21 is a top perspective view of a seal plate component of the air cleaner assembly of FIG. 1.

FIG. 22 is a bottom perspective view of the seal plate component of FIG. 21.

FIG. 23 is a top plan view of the seal plate component of FIGS. 21 and 22.

FIG. 24 is a bottom plan view of the seal plate component of FIGS. 21-23.

FIG. 25 is a cross-sectional view taken along line 25-25, FIG. 24, depicting the seal plate component of FIGS. 21-24 with an upper portion in use directed upwardly.

FIG. 26 is a side elevational view of the seal plate component depicted in FIGS. 21-25.

### DETAILED DESCRIPTION

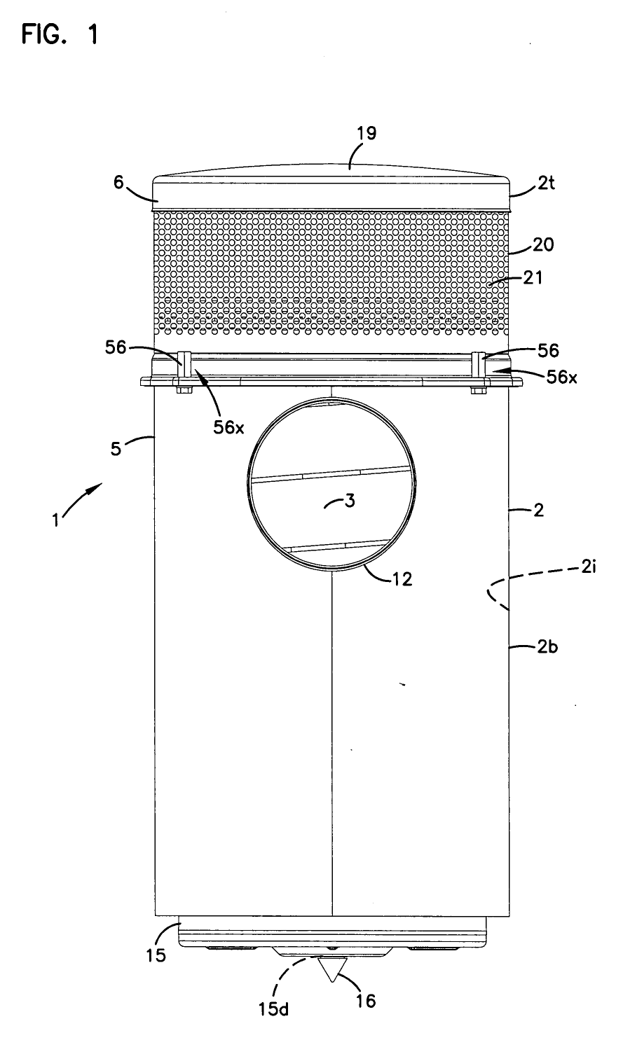

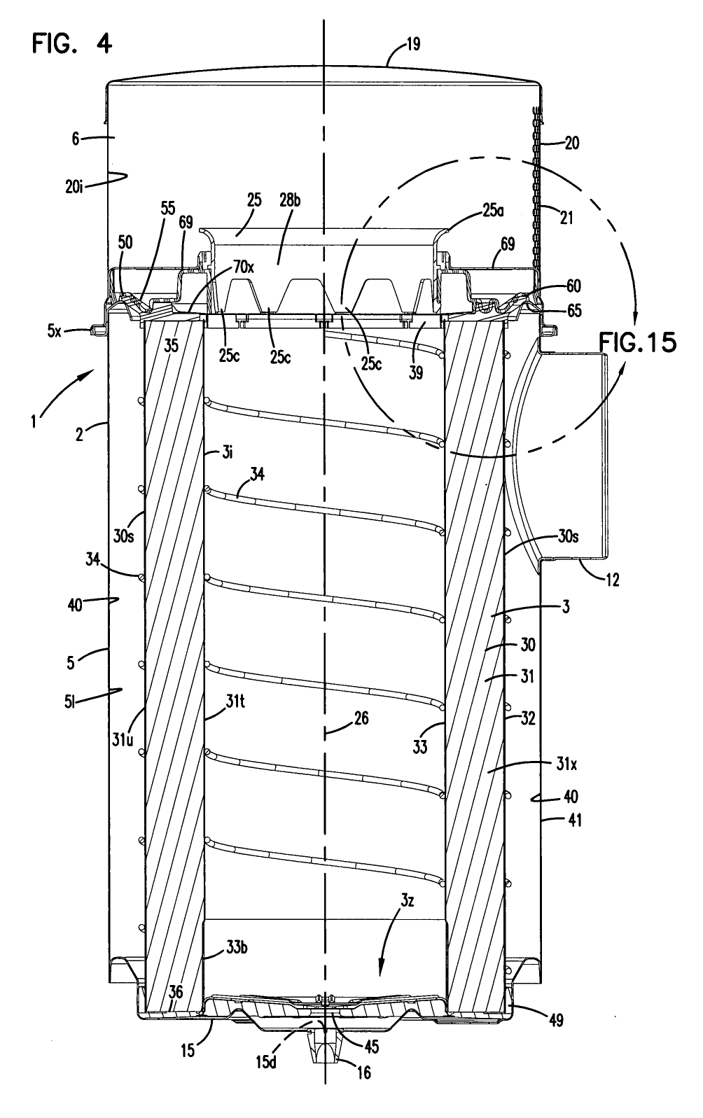

The reference numeral 1, FIG. 1, generally indicates an air cleaner assembly according to the present disclosure. The air cleaner assembly 1 includes a housing 2 defining an interior 2i, and an internally received, removable and replaceable, i.e., serviceable, filter cartridge 3, not fully viewable in FIG. 1, see for example FIG. 4.

The housing 2, FIG. 1, generally includes a body or base 5 and a removable inlet/access (service) cover assembly 6. When the inlet/access (service) cover assembly (or cover) 6 is removed from a remainder of the air cleaner housing 2, i.e., from base 5, service access to interior structure, for servicing of the filter cartridge 3, is provided.

The typical operational orientation for air cleaner assembly 1 is in the orientation of FIG. 1, i.e., with inlet/access cover assembly 6 positioned above, and mounted on, base 5. Thus, referring to FIG. 1, the air cleaner housing 2 includes a top portion 2t comprising inlet/access (service) cover assembly 6, and a bottom portion 2b comprising housing base 5.

The inlet/access cover assembly 6 is configured to allow inlet flow of air to be filtered into the inlet/access cover assembly 6, and thus into air cleaner assembly 1. Internal structure within inlet/access cover assembly 6 will direct the incoming air into body or base 5, for filtering. This is discussed further below, in connection with other figures.

The housing base 5, for the example shown, generally has a circular shaped perimeter shape or cross-sectional definition, although alternatives are possible. The housing 2 includes, in base 5, an air flow outlet 12, FIG. 1. The outlet in the form of outlet tube 12 allows for passage of filtered air from the air cleaner assembly 1 to downstream equipment, such as an engine combustion air intake for the vehicle (typically a truck) or an intake for other equipment involved.

Referring still to FIG. 1, base 5 includes a lower end piece or cover 15. The lower end piece or cover 15 would typically include a drain aperture 15d therein, shown in FIG. 1 as covered by evacuator valve 16. The lower central drain aperture 15d and evacuator valve 16, allow, for example, for selective drainage of water that may collect in an interior of air cleaner assembly 1 during use.

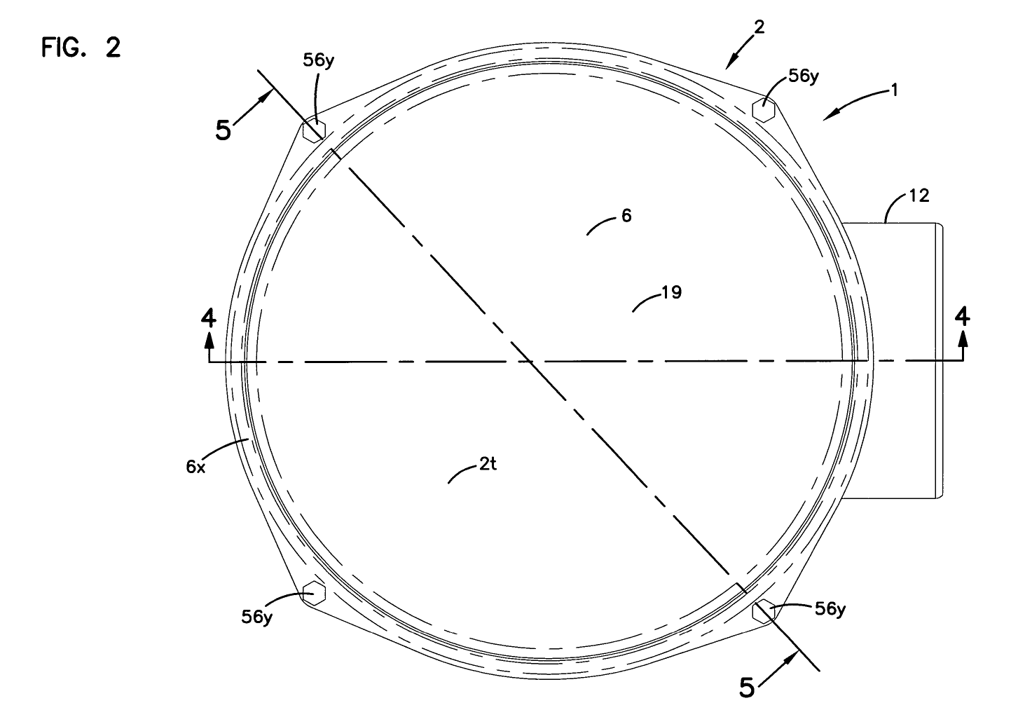

In FIG. 2, a top plan view of air cleaner assembly 1 is viewable.

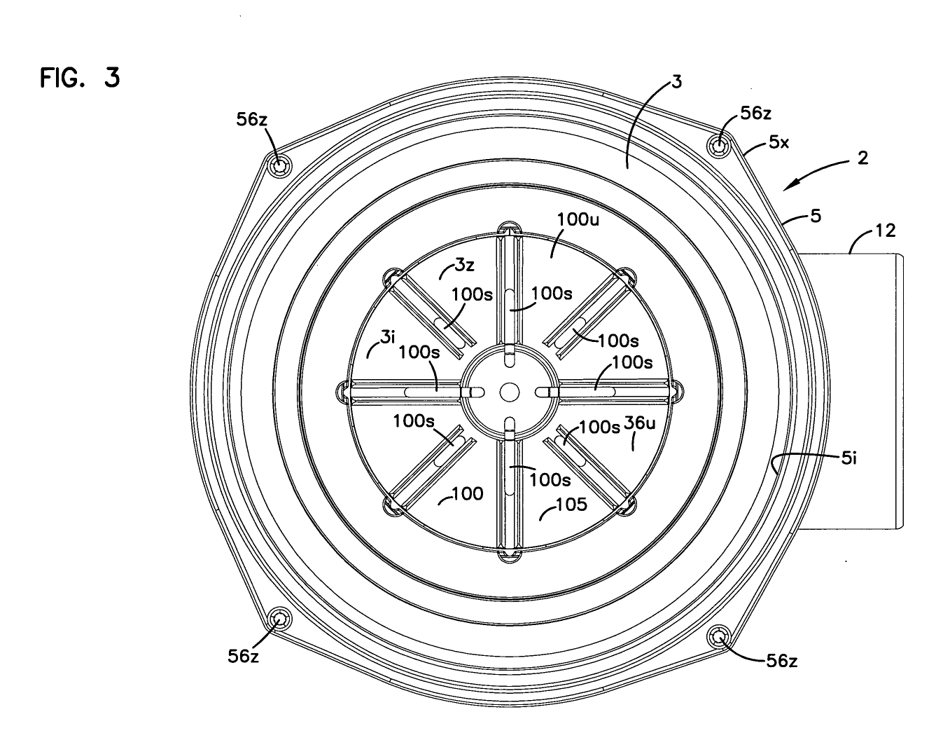

In FIG. 3, base 5 of assembly 1 is depicted, with inlet/access cover assembly 6 removed. With an interior 5i of base 5, one can view serviceable filter cartridge 3. Referring to FIGS. 1 and 3, one can see that the cartridge 3 has a generally circular cross-section, and the base 5, but for outlet 12, has a generally circular cross-section. In FIG. 3, flange 5x is viewable projecting outwardly from an upper portion of base 5. Flange 5x allows for securing of inlet/access cover assembly 6 (FIG. 1) in place. This is described in further detail below.

Still referring to FIG. 3, it is noted that a bottom interior 3z of cartridge 3 is also viewable in FIG. 3. This portion of cartridge 3 is discussed further below.

Attention is now directed to FIG. 4, a cross-sectional view taken along line 4-4, FIG. 2. From reference to FIG. 4, general operation of air cleaner assembly 1 can be understood. Inlet/access cover assembly 6 includes a top 19 and side screen arrangement 20. The top 19 is secured to the side screen arrangement 20, for example by welding. The side screen arrangement 20 includes perforate perimeter screen portion or region 21. Air to be filtered can pass into an interior 20i of inlet/access cover assembly 6 to a location surrounded by screen 20, by passage through perforated (perforate) screen region 21. Perforated (perforate) screen region 21 would typically extend all the way around an outer circumference of screen 20. Perforated portion 21, i.e., side screen 20, thus allows for inlet flow of air to be filtered into housing 2.

Unfiltered air entering side screen arrangement 20 is directed into base 5, through inlet stack or inlet tube 25. More specifically, inlet stack 25 directs air flow into interior 3i of filter cartridge 3. Flange 69 extends from screen 20 inwardly and engages stack 25 in a manner discussed below.

For the example shown in FIG. 4, inlet stack or inlet tube 25 comprises an upper outer flared end 25a and a central axial tube section 25b, for facilitating collection of inlet air in region 20i and directing it into cartridge interior 3i. Herein the term “axial” is used to refer to features generally in line with a central axis of housing 2 and cartridge 3; the central axis generally being oriented to extend vertically when assembly 1 is in an installed position. A line generally corresponding to such a central axis line, is indicated at 26, FIG. 4. Hence the previously used term “axial tube section 25b,” refers to a tubular section 25b that extends generally around, and in line with tube axis 26; and, directs air flow in the general direction of line 26. (Herein, a radial direction is generally toward or away from line 26.)

Inlet stack or inlet tube 25 further includes lower spaced projections 25c which provide for assembly engagement, as discussed below.

Filter cartridge 3 generally comprises a media pack 30 including filter media 31 surrounding open interior 3i. The media pack 30 can further include an outer liner 32 and/or an inner liner 33, supporting the media 31 on one or both of opposite sides. Typically, both an outer liner 32 and an inner liner 33 are used, each comprising an expanded metal liner. In the example shown, the media pack 30 has a circular, cylindrical, outer perimeter shape, although alternatives are possible.

Referring to FIG. 4, for the example shown, at a lower portion of inner liner 33, indicated at 33b, the inner liner 33 optionally includes a portion of slightly expanded outer diameter. This facilitates manufacturing, by helping to secure media pack 30 together, during handling.

Typically, pleated filter media 31x will be used for the media 31 with inner and outer pleat tips extending between opposite end caps 35, 36, although alternative media is possible. When pleated media 31x is used, a bead arrangement 34 can be used to facilitate pleat spacing, on one or both of inner pleat tips 31t and outer pleat tips 31u. Such bead arrangements are known and used for conventional pleated media. In addition, the media 31 can be provided with embossing or other folds therein, to facilitate pleat spacing; and, the media can be provided with corrugations extending generally perpendicular to the pleat direction, again to facilitate pleat spacing. These techniques are also known and utilized in conventional pleated media arrangements. Further, in some instances the media 31x can be treated with a fine fiber treatment on one or both sides thereof. Again, such techniques are known and used in some prior air filters.

Referring to FIG. 4, the media pack 30, including the media 31, extends between opposite end caps 35, 36. End cap 35 has a large open, central, inlet aperture 39 around which media pack 30 extends. This aperture 39 allows unfiltered air to pass into interior 3i of filter cartridge 3. Filtering flow of air then occurs as the unfiltered air moves from central region 3i through the media pack 30, with the resulting filtered air flowing into annular region or annulus 40. Annulus 40 is a clean air annulus surrounding the media pack 30 and cartridge 3, between the media 31 and housing base side wall 41. The filtered air from annulus 40 can then pass outwardly from air cleaner 1, through outlet 12. From outlet 12, the filtered air is generally directed through appropriate duct work into the engine air intake for vehicle or other equipment involved.

The majority of dust and other material removed from the unfiltered air, generally remains in interior 3i of filter cartridge 3, FIG. 4.

In typical orientation and use, end cap 35 is an upper or top end cap, and end cap 36 is a lower or bottom end cap; the cartridge 3 typically being oriented for use in the orientation shown in FIG. 4.

Bottom end cap 36, FIG. 4, includes a drain aperture arrangement 45 therein. Drain aperture arrangement 45 provides an axial flow passageway through end cap 36; i.e., from interior 3i into bottom 15 of housing 2. This allows, for example, for drain of material such as water (for example rain water) from cartridge interior 3i, through drain arrangement 15d and evacuation valve 16.

Since end cap 36 includes drain aperture arrangement 45 therein, end cap 36 is not completely closed. Air cleaner assembly 1, then, requires a housing seal arrangement: (a) inhibiting unfiltered air in region 3i bypassing the media pack 31 upon passage through drain aperture arrangement 45, from reaching clean air annulus 40; and (b) inhibiting any unfiltered air passing into bottom 15 of housing 2 through drain aperture 15d, from entering annulus 40. This is provided by a housing seal arrangement 49. The particular example housing seal arrangement 49 depicted involves end cap 36 and is discussed in more detail further below. A variety of alternate housing seal arrangements, for housing seal arrangement 49, however, can be used.

Herein, the term “housing seal arrangement” is generally meant to refer to a seal material positioned on the cartridge 3, which seals to a portion of the housing 2, during assembly. Unless the term is otherwise qualified, it is not meant to indicate a specific type, location or direction of seal.

Another housing seal arrangement is important to operation of air cleaner assembly 1. This seal arrangement is indicated generally at 50, and is positioned to inhibit the unfiltered air which enters screen interior 20i (or otherwise entering housing 2 from the exterior environment) from entering annulus 40 without filtering passage through media 30 of filter cartridge 3.

Referring to FIG. 4, air cleaner assembly 1 includes seal plate assembly 55. The seal plate assembly 55 is secured in the inlet/access cover assembly 6. When fastener system 56, FIG. 1, is released, the inlet/access cover assembly 6, including the seal plate assembly 55, can be lifted off housing base 5. Although alternatives are possible, the fastener system 56 typically comprises a bolt/nut arrangement 56x that drives the seal plate assembly 55 downwardly, toward housing bottom 15. The seal plate assembly 55 is discussed in more detail in connection with other figures below.

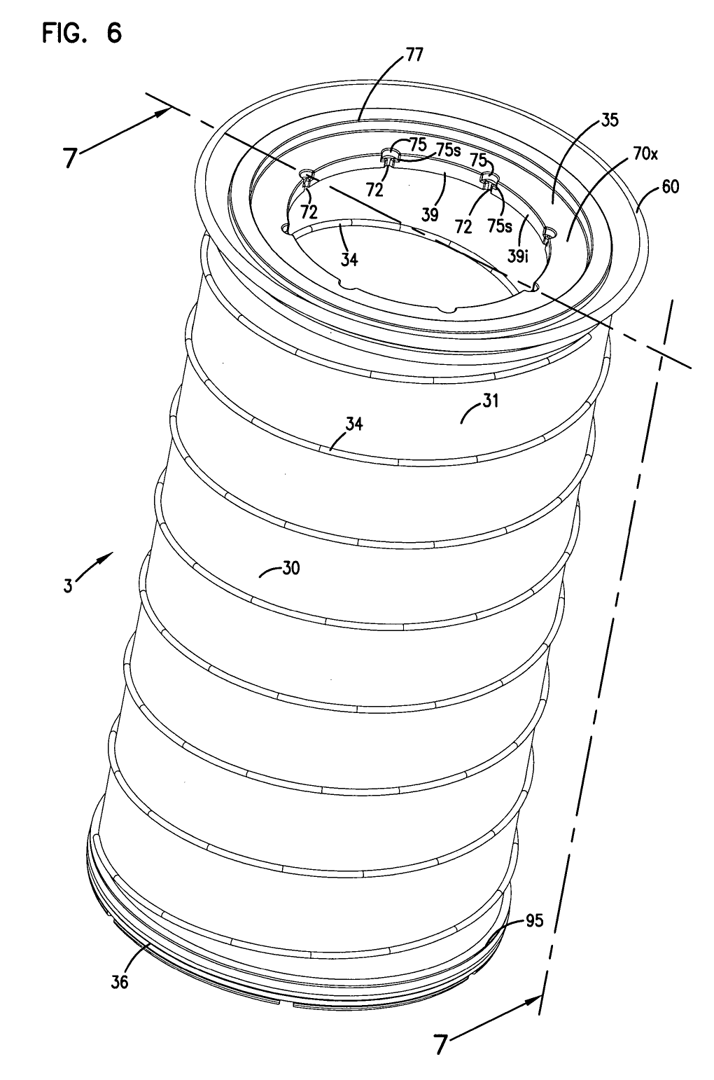

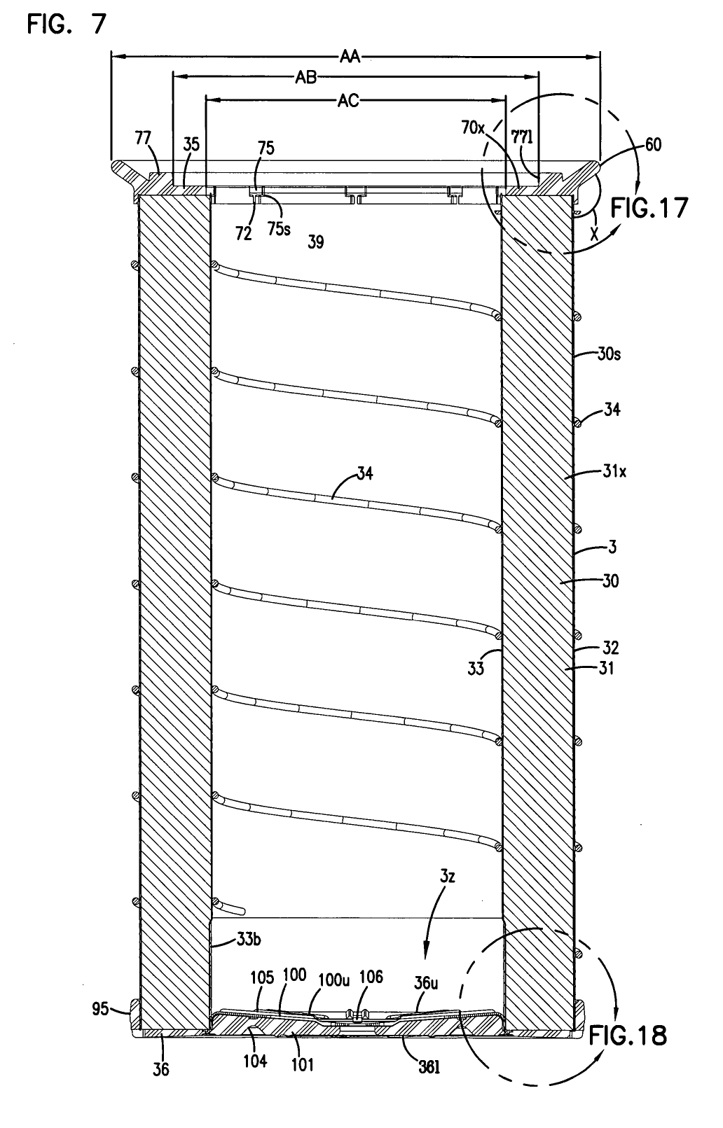

Referring still to FIG. 4, cartridge end cap 35 is provided with outwardly directed pinch seal flange 60 thereon. The outwardly directed pinch seal flange 60 forms of housing seal arrangement 50, previously identified. The seal flange 60 comprises a flexible extension, directed outwardly away from a remainder of end cap 35, i.e., away from axial end portion 70x, FIG. 6, in a direction radially outwardly from an outer surface 30s of media pack 30 and also outwardly from the aperture 39. Typically flange 60 is also directed axially away from opposite end cap 36 and the media pack 30. That is, typically and preferably, flange 60 extends outwardly generally at an angle x, FIG. 7, with respect to the outside side 30s of the media pack 30 which is greater than 90°, i.e., flange 60 extends both radially outwardly from media pack 30 and also axially away from opposite end cap 36. The term “pinch seal flange” as used herein is meant to refer to a seal flange configured to be clamped or pinched between, typically in contact with, two housing members to form a seal, in use.

For the arrangement shown, the seal flange 60 is inseparable from a remainder of end cap 35. For a typical example, the end cap 35, with seal flange 60, is molded-in-place, although alternatives are possible.

In the example shown, pinch seal flange 60 defines a circular outer perimeter, although alternatives are possible. The outer perimeter defined by pinch seal flange 60 is typically greater than the perimeter defined by the media pack 30.

For the particular example shown, FIG. 7, end cap 35 comprises a relatively soft, compressible, material.

Referring to FIG. 4, in assembly 1, the flange 60 is compressed (pinched or clamped) between a portion of seal plate assembly 55 and a portion of a housing seal support 65 under axial pressure applied by fastener arrangement 56. This forms housing seal arrangement 50 between cartridge 3 and housing 2 at a top end of the cartridge 3.

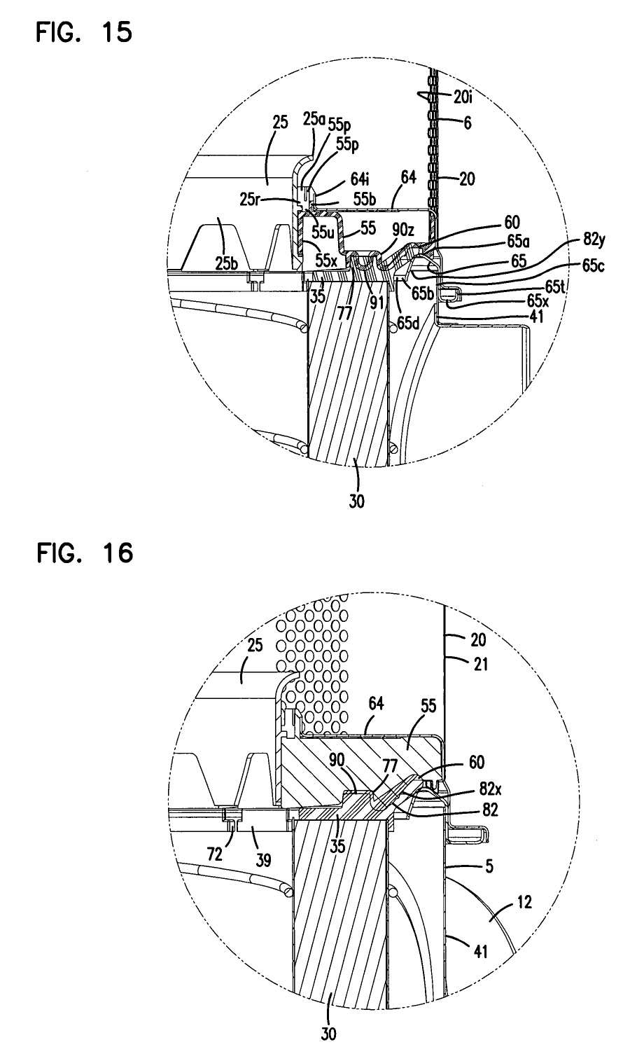

With respect to this, attention is directed to FIG. 15, an enlarged fragmentary view of a portion of FIG. 4. Referring to FIG. 15, housing seal support 65 comprises upper central portion 65a, radially inward, depending, portion 65b and radially outward, depending, portion 65c. Inner depending portion 65b defines an inner aperture 65d through which cartridge 3 projects. In particular aperture 65d surrounds end cap 35, with media pack 30 depending from end cap 35. Central section 65a comprises a shoulder against which seal flange 60 is compressed or pinched, by seal plate assembly 55, during installation.

Depending portion 65c surrounds a portion of sidewall 41, and forms a lower flange/stop 65x, for supporting a portion of fastener arrangement 56, FIG. 1. Typically seal support 65 is mounted to sidewall 41, although alternatives are possible. An upwardly turned tip 65t, to an outside 65x, operates as a compression stop when fastener 56 is engaged.

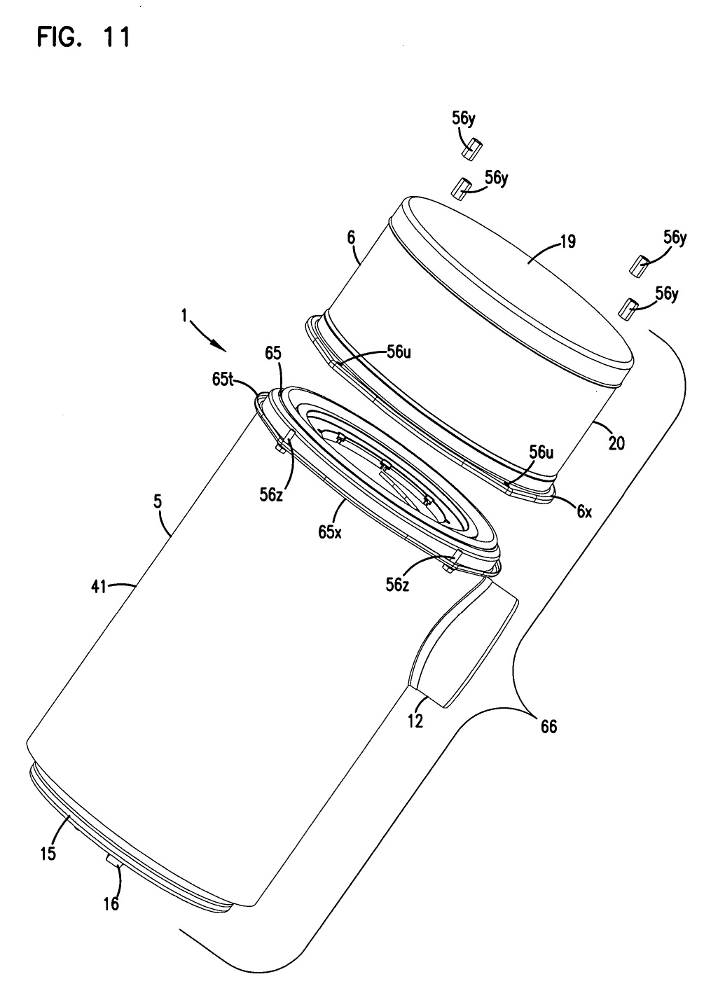

Further regarding the seal features characterized can be understood by reference to FIGS. 11-13. Referring first to FIG. 11, an exploded perspective view is shown depicting selected exterior portions 66 of the air cleaner assembly 1. In particular exterior portions of inlet/access cover assembly 6 and housing base 5 are shown. Referring to FIG. 11, inlet/access cover assembly 6 can be seen to include top 19 and screen arrangement 20. The inlet/access cover assembly 6 is secured to base 5 by fastener arrangement 56 (FIG. 1) comprising nuts 56y and threaded bolt posts 56z, FIG. 11. Bolts 56z are positioned on flange 65x discussed above.

Also viewable in FIG. 11 is outlet 12 in base portion 5.

Still referring to FIG. 11, it can be seen that sidewall 41 of base 5 is provided an upper outwardly directed flange 5x thereon as a result of seal support 65, and an open, in use upper, end 5u. The outwardly directed flange 5x includes bolts 56z of fastener system 56 secured thereon, upwardly directed. A cartridge installation opening at the open upper end 5u is defined by seal support 65. Cover 6 includes an outwardly directed flange 6x thereon, with apertures 56a therein. In use, cover 6 can be fit onto bottom 5 with bolts 56z projecting through apertures 56a. Nuts 56y can then be applied, for securement. Typically, componentry will be designed and configured so that the nuts 56y are tightened until a metal-to-metal engagement between flange 6x of cover 6 and flange 5x (i.e., flange 65x) on base 5 occur.

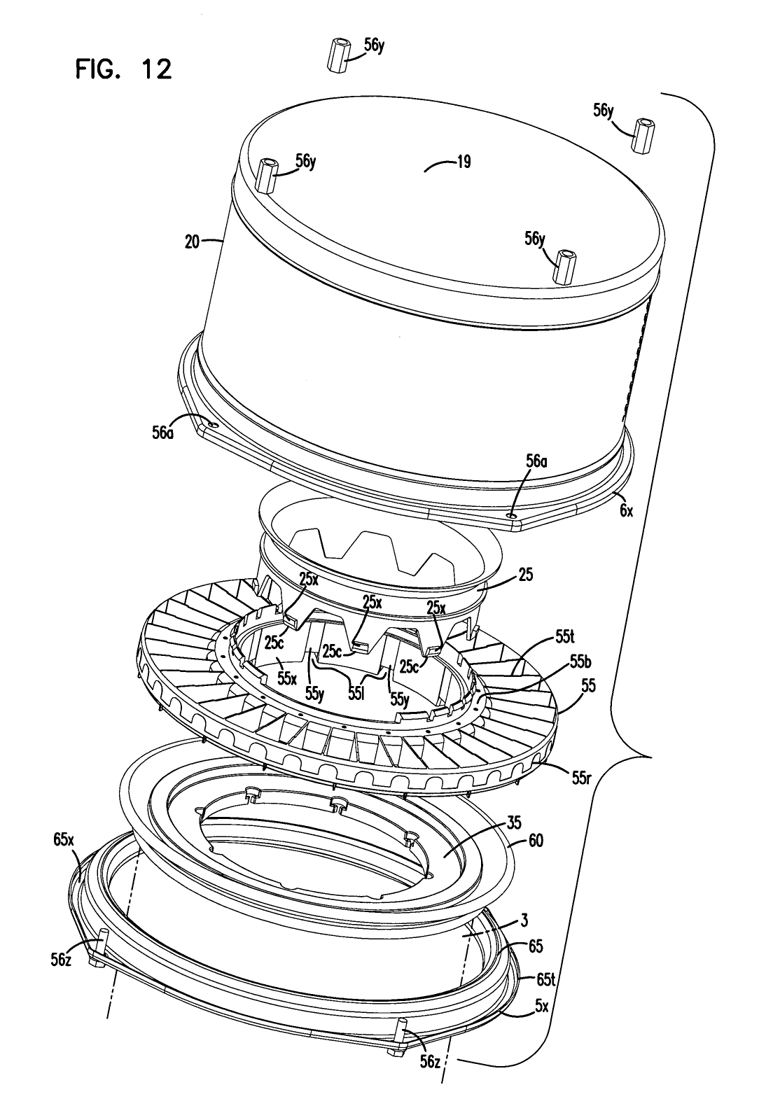

Referring to FIG. 12, certain interior structural componentry is depicted. In particular, inlet stack 25 is viewable, having depending snap fit projections 25c, with radial outer protrusions 25x for snap fit within an interior of hub 55x of the seal plate assembly 55. An inner surface of hub 55x includes a plurality of spaced, vertical, grooves or channels 55y therein, one each associated with each of the snap fit projections 25c. The channels 55y help the projections 25c to relatively easily reach an engaged position with hub 55x.

The seal plate assembly 55 can be seen as including central tubular hub or section 55x, plate section 55z, and outer rim 55r. Also shown in FIG. 12 are seal support 65 and end cap 35 of cartridge 3, with pinch seal flange 60.

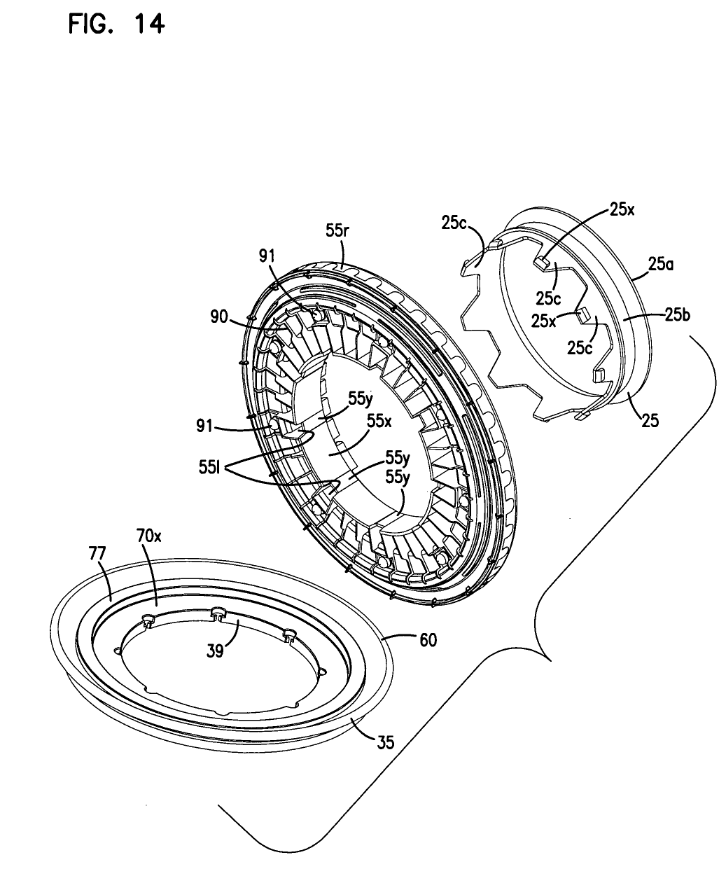

In FIG. 14, selected portions of the assembly 1 are depicted, in particular inlet stack 25, seal plate 55 and end cap 35. In this view, end cap 35 is shown fragmented from a remainder of the cartridge 3. The view of FIG. 14 can be used to help understand interaction between these parts, discussed further below.

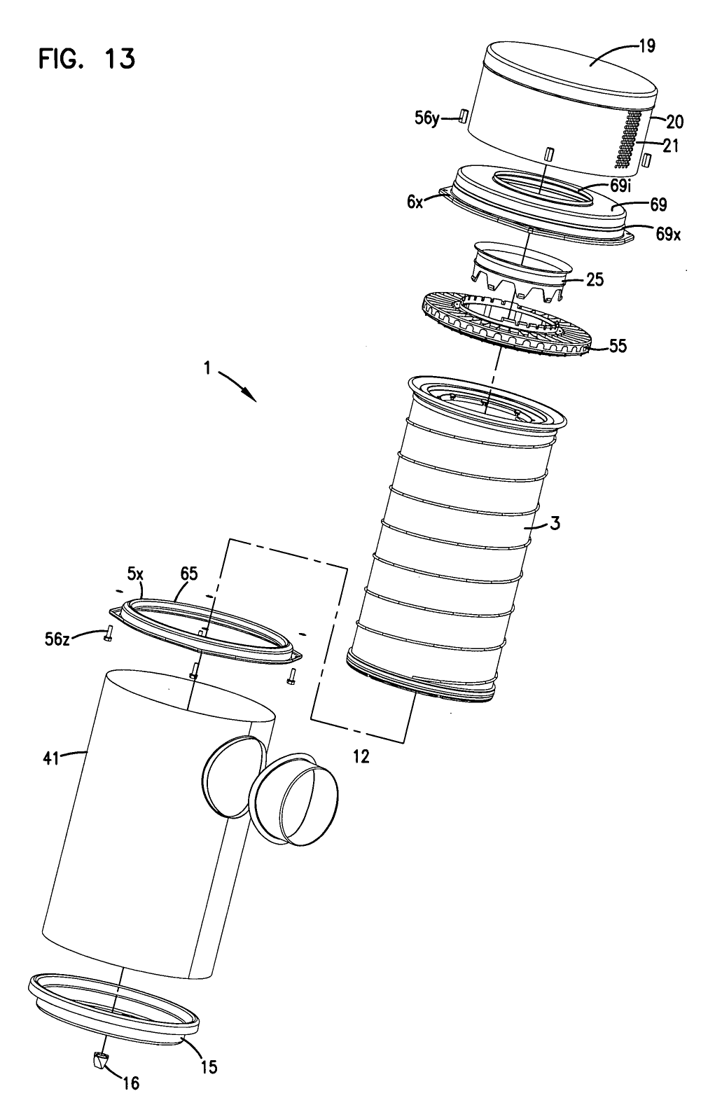

In FIG. 13, an exploded view of the air cleaner assembly 1 is shown. It can be seen that shoulder 69 with upwardly turned inner flange 69i, is a portion of a plate component 69x which includes mounting flange 6x thereon. Typically plate component 69x would be a metal component, secured to screen 21 by welding.

Referring again to FIG. 4, a first snap fit connection is also used to secure inlet stack 25 to plate 55, and a second snap fit connection is sued to secure the snap fit combination of inlet stack 25 and top plate 55 to a remainder of inlet/access cover 6. More specifically, the inlet stack 25 and seal plate 55 can be snapped together as previously described, utilizing projections 25c, with outwardly extending protrusions 25x, FIG. 12, under selected portions of lower rim 551 (FIG. 14) of hub 55x. Typically where protrusions 25x engage lower rim 55l, slightly raised portions of rim 55l are provided, so that a bottom end of stack 25 provides for an even lower surface and the resulting combination.

Referring now to FIG. 15, the inlet/access cover 6 is provided with mounting shoulder 69 extending radially inwardly from screen 20. The mounting shoulder 69 is provided with an inner upwardly turned flange 69i. The inlet stack 25 includes an outwardly projecting annular rib 25r around region 25b. Plate 55 includes an inner downwardly turned projection forming hub 55x and an upper surface 55u adjacent hub 55x, with an upwardly directed rib, bead or shoulder projection 55b. The projection 55b includes a plurality of upwardly directed snap fit projections 55p.

Referring to FIG. 15, it can be seen that as a combination comprising plate 55 and snap fit inlet stack 25 is pushed into interior 20i of screen 20 with piece 69x in place, when mounting shoulder 69 is encountered, snap fit will occur with projections 55p over inner flange 69i of mounting shoulder 69. This will secure the combination of inlet stack 25 and plate 55 into place in the inlet/access service cover 6. Thus, when the inlet/access service cover 6 is removed from a remainder of air cleaner 1, inlet stack 25 and seal plate 55 are also removed as part of the inlet/access service cover assembly 6.

Referring to FIG. 12, when the snap fit of plate 55 and inlet stack 25 into flange 69 occurs, during initial assembly of housing 2, typically an adhesive is applied to inner rim portion 55b of plate 55, to facilitate securement. In addition, adhesive is also provided around rim 55r to facilitate secure engagement.

It can be understood from FIGS. 1, 4 and 12 that once the nuts 56y are loosened, by lifting screen member inlet/access cover 6 (which is secured to seal plate assembly 55), the seal plate assembly 55 is lifted away from the cartridge 3. The cartridge 3 could then be lifted out of the assembly and be replaced by a new cartridge.

Installation of the new cartridge 3 would be a reverse operation.

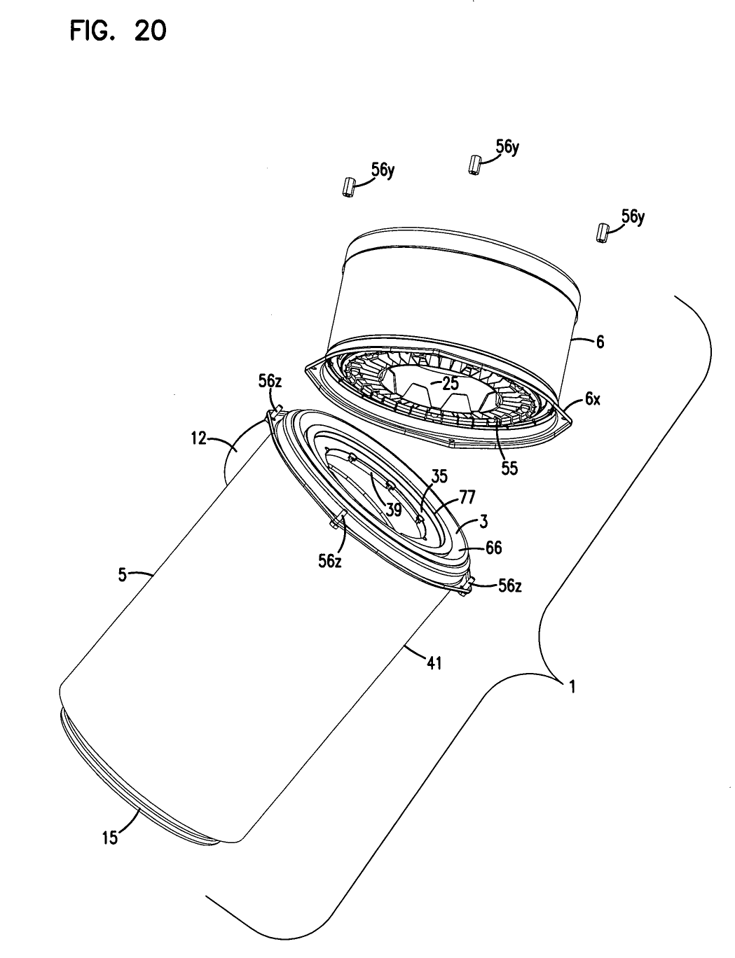

In FIG. 20, air cleaner assembly 1 is shown in a view somewhat analogous to FIG. 11, except with the inlet/access (service) cover assembly 6 bent from overlap with the base 5, as well as separated. In this figure, interior portions of the inlet/access (service) cover assembly 6 can be viewed, for convenience.

The assembly 1 thus far described can be constructed from a variety of materials. Typically exterior surfaces of the inlet/access service cover assembly 6, and the body 5, which are visible during installation, comprise a highly polished stainless steel, for appearance. Typically the top 19, screen 20 and flange assembly or piece 69x, of the inlet/access service cover assembly 6 comprise metal components, secured together, for example, by welding, i.e, formed in a metal fabricating process. Also typically base 5 portions comprising side wall 41, bottom 15, flange 5x, outlet tube 12 and upper shoulder 65 comprise metal components, again made by metal fabricating processes and, where appropriate, welded together.

Typically the inlet stack 25 and seal plate 55 will comprise molded plastic components, typically a plastic selected for rigidity strength, for example a glass filled nylon material.

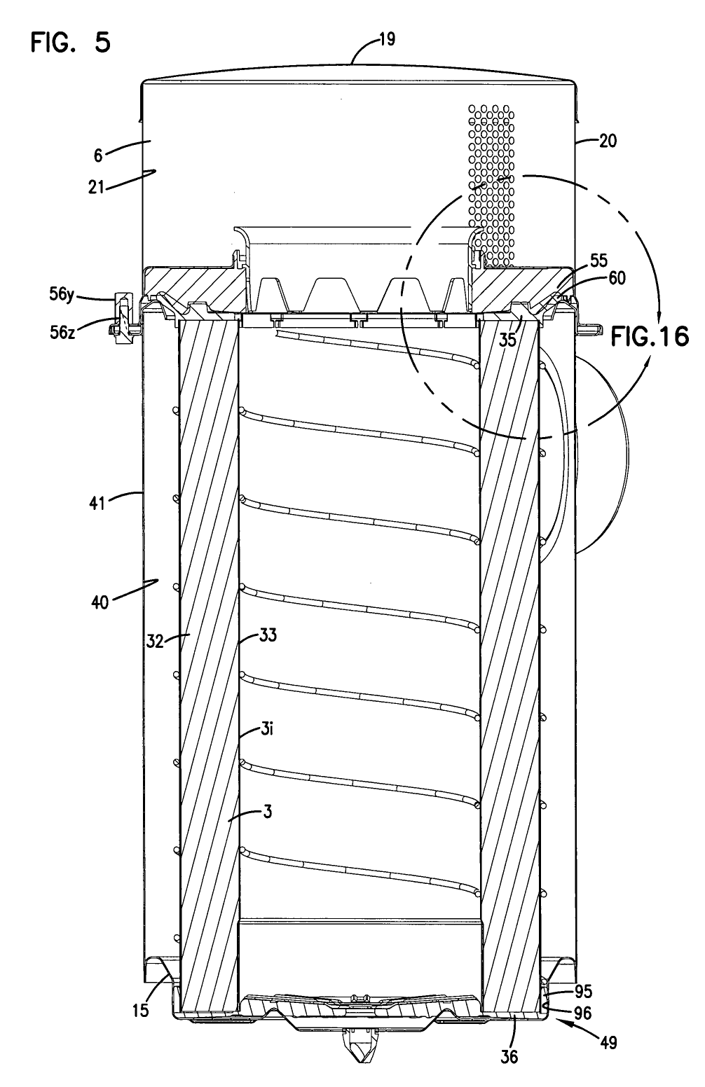

Attention is now directed to FIG. 5. In FIG. 5, a cross-sectional view taken along line 5-5, FIG. 2 is shown. The view is analogous to FIG. 4, except the cross-sectional line taken shows different features of the seal plate 55. In FIG. 5, end cap or piece 35, including pinch flange 60, is drawn in a non-compressed, non-distorted, shape, with portions overlapping seal plate 55. This is intended to show where compression and interaction between these components occurs, during installation and sealing. In actual use, for example, pinch flange 60 would be distorted by the seal plate 55 in the regions indicated, by an amount corresponding to the amount of overlap between the two components.

Similarly, at seal region 49, overlap between an annular portion of end cap 36, and a portion of bottom 15, shows an amount of compressed end cap material, to form a seal at this location. This example seal is discussed further below.

Attention is now directed to FIG. 6, in which cartridge 3 is depicted in perspective view; media pack 30 being shown schematically extending between end caps 35 and 36. In FIG. 6, the cartridge 3 is depicted in a top perspective view, meaning that the cartridge 3 is oriented with an upper portion or end cap 35 positioned above lower portion or end cap 36, as it normally would be during installation in an air cleaner for use.

Referring to FIG. 5, end cap 35 includes pinch seal lip 60 and axial end portion 70x. End portion 70x generally extends axially over an end of media pack 30, defining open central aperture 39 surrounded by media pack 30. In the example shown, central (in the example, circular) aperture 39 includes an inner surface 39i including at least one, and typically a plurality of, spaced insets or channels 72 therein. Each one of insets or channels 72 extends vertically through a portion of end cap 35 and is open to (i.e., is in communication with) aperture 39. For the example shown, the number of insets 72 is eight (8), however alternate numbers can be used. Typically there will be at least four (4) insets 72 and usually not more than twelve (12) insets 72, although alternatives are possible. For the example shown, the insets 72 are generally semicircular in cross-section, although alternatives are possible. The insets 72 are typically end cap artifacts from centering pins in a mold operation, used to center the media pack 30 in an appropriate location. With some manufacturing techniques the insets 72 can be avoided.

Still referring to FIG. 5, end cap 35 also includes, positioned around aperture 39, standoff recesses 75. The standoff recesses 75 are mold artifacts, from where mold standoffs would be positioned, to support the media pack 30, during molding of end cap 35. Each standoff recess 75 includes a standoff shoulder 75s. Extending downwardly from each standoff shoulder 75s, is provided an inset 72. In combination with the associated standoff recess 75s, each inset 72 extends completely through end cap 35, in a vertical dimension. With some manufacturing techniques, recesses 75 can be avoided.

Positioned on surface 35 of ring portion 70x of end cap 35, is positioned axial ring projection 77. The axial ring portion 77 is ring shaped projection on end cap 35 positioned between pinch seal flange 60 and aperture 39. It is generally positioned projecting away from media pack 30 and in axial overlap with an end of media pack 30; i.e., the ring 77 is in axial overlap with an end of the media 31 within media pack 30. For the particular example shown, the axial ring 77 is a continuous ring, although alternatives are possible.

For the example shown, the axial projection ring 77 is positioned adjacent, and surrounded by, pinch seal flange 60. In some alternate applications, the ring 71 can be spaced from the flange 60.

The insets 72, projection 77 and mold standoffs 75 are typically molded integral with the remainder of end cap 35.

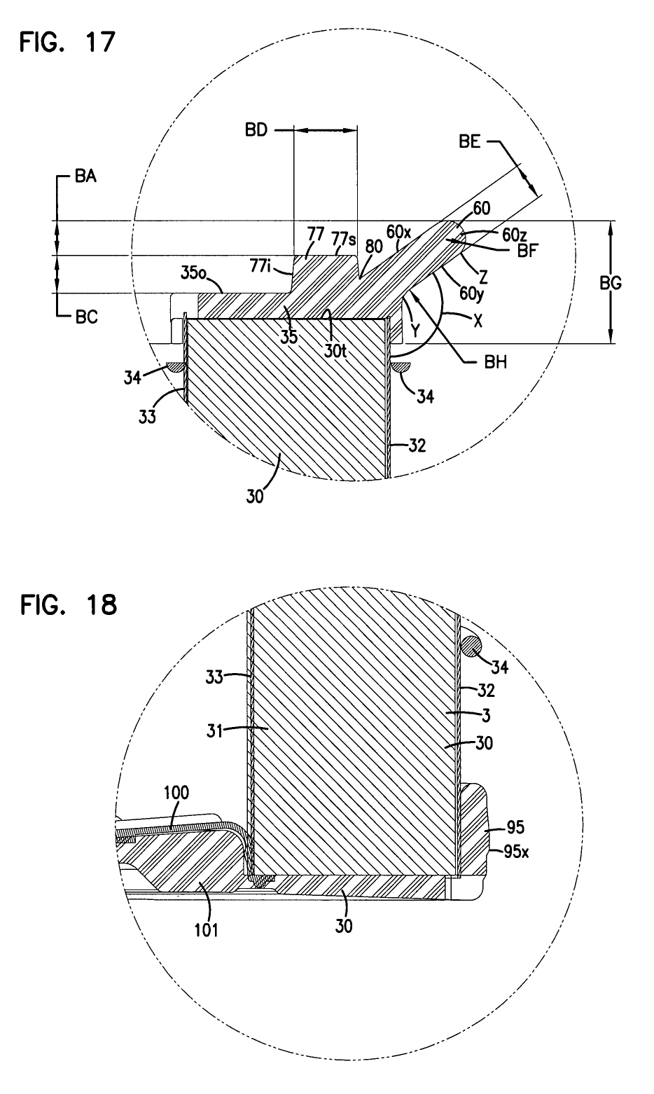

Attention is directed to FIG. 17, an enlarged fragmentary view of a portion of FIG. 7, in which end cap 35 is depicted in cross-section. Seal member 60 is viewable. For the example shown, angle x is an obtuse (>90°, <180°) angle from under side of pinch seal member 60 (toward opposite end cap 36 (FIG. 4)) and between a direction of extension of lip 60, and a side or perimeter of media pack 30. The angle x is typically at least 95°, usually not more than 170°, and often at least 110°, for example within the range of 110°-170°, inclusive; typically 115°-160°, inclusive. The typical example shown x is within the range of 120°-140°, inclusive. Seal lip 60 has opposite, generally parallel, sides 60x, 60y and a curved end 60z. The opposite sides 60x, 60y generally extend parallel or nearly parallel with one another, spaced apart by a distance (BE) appropriate for the sealing of the material used, typically the distance (BE) being within the range of about 5-20 mm, inclusive; typically 7-15 mm, inclusive.

The length of side 60y from vertex y to location z, where curved end 60z begins the curve, is usually at least 10 mm, typically 10 to 20 mm, inclusive; for example 12-18 mm, inclusive. In the example shown, side 60x, from vertex 80 to where curve 60x begins, is slightly longer.

A variety of materials can be utilized for the molded end cap 35. Typically a molded-in-place end cap 35 comprising a compressible, polyurethane foam; for example having an as molded density of no greater than 30 lbs/cu. ft. (0.48 g/cc), sometimes no greater than 16 lbs/cu. ft. (0.25 g/cc) and in typical instances no less than 8 lbs/cu. ft (0.12 g/cc), is used, although alternatives are possible. Example of useable materials are compressible polyurethane foams as described for example in U.S. Pat. No. 5,670,712, incorporated herein by reference. However, alternatives are possible.

Typically, the material in end cap 35 will have a hardness, Shore A, of no greater than about 25, typically no greater than about 22, usually within the range of 10 to 22, inclusive; although alternatives are possible.

Attention is now directed to projection 77, FIG. 17. As discussed previously, the projection 77 forms a ring which projects axially away from media pack 30 in a direction away from end cap 36, FIG. 7. The ring 77 is in axial overlap with the media 31 of media pack 30. For the particular example, ring 77 is continuous, although in some instances alternatives are possible. For the example shown the ring 77 is positioned adjacent pinch seal flange 60, in particular positioned adjacent to radially inner end 80 of side 60y, although alternatives are possible.

The projection 77 includes an outer, axial, end surface 77s. The surface 77s generally has a radial width, dimension BD, FIG. 17, on the order of at least 8 mm, typically at least 10 mm and usually not more than 25 mm. Typically the dimension BD is within the range of 12-20 mm, inclusive. A specific example is described below.

The height of axial projection 77, adjacent a radial inner surface 77i, indicated by dimension BC, FIG. 17, is usually at least 4 mm, typically at least 5 mm and often within the range of 5 mm-15 mm, inclusive. This height, characterized as BC, FIG. 17, is a distance of surface 77i from an adjacent, inner, lower portion of end cap 35, generally designated at 35o, FIG. 17.

Referring to FIG. 6, for the example shown, ring 77 is a continuous, circular, ring. Alternatives are possible, for example in which the ring 77 is not continuous, or has a cross-sectional definition that is not completely consistent, throughout its extension. However, continuous rings of constant, consistent, shape for axial projection 77 are typical and convenient.

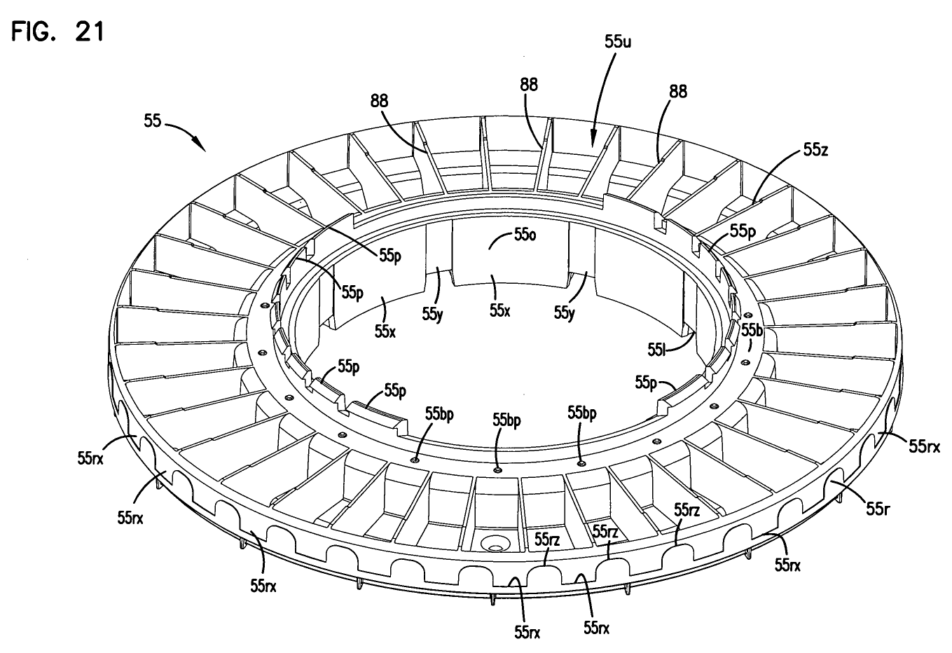

As will be understood from the detailed description below, the projection 77 is sized and shaped to be received within a receiver channel 90 on seal plate 55, to advantage during installation of cartridge 3 within air cleaner assembly 1. Before this is discussed in detail, a more detailed review of seal plate 55 is made. With respect to this, attention is directed to FIGS. 21-26.

Referring first to FIG. 21, a top perspective view of seal plate 55 is shown. Features already described, for example hub 55x with channels 55y therein; adhesive loading surface 55b, outer rim 55r and plate region 55z are viewable. Also viewable are spaced projections 55p discussed previously, used for snap fit of the seal plate 55/inlet stack 25 combination, to the flange 69, FIG. 15, to secure the seal plate 55 and inlet stack 25 into the inlet/access cover assembly 6, FIG. 4.

The outer rim 55r can be seen to include irregular surface features that allow for recesses 55rx, and regions 55r, for adhesive during installation.

Region 55b includes projections 55bp, to provide even spacing during assembly.

Referring to FIG. 21, it is noted that projection 55p do not completely circumscribe aperture 55o. Spaces in between rows of projections 55p are a result of a preferred manufacturing operation, for molding of plate 55p. Alternatives are possible.

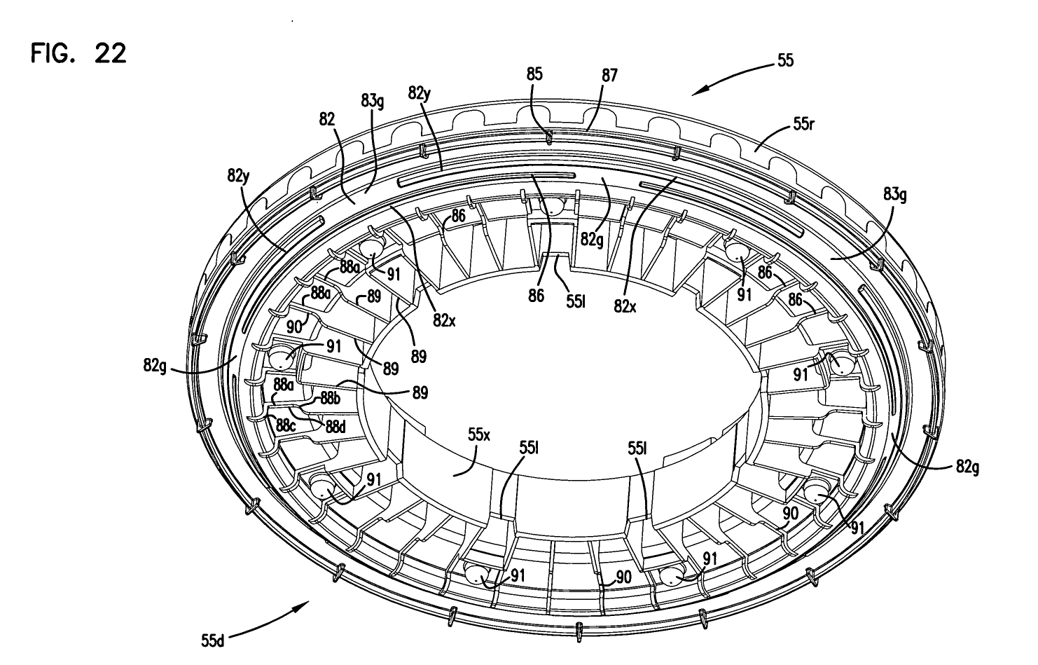

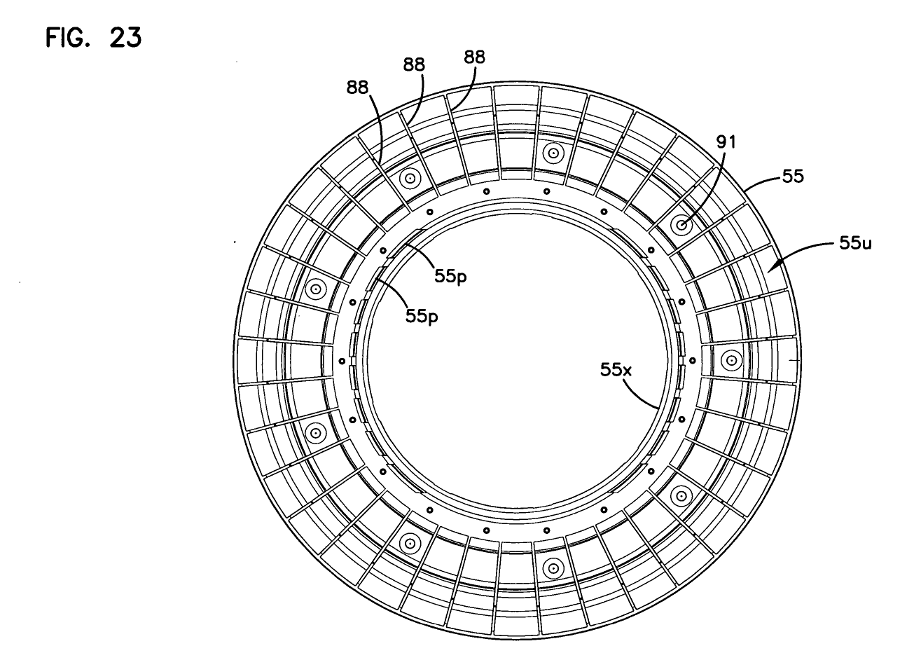

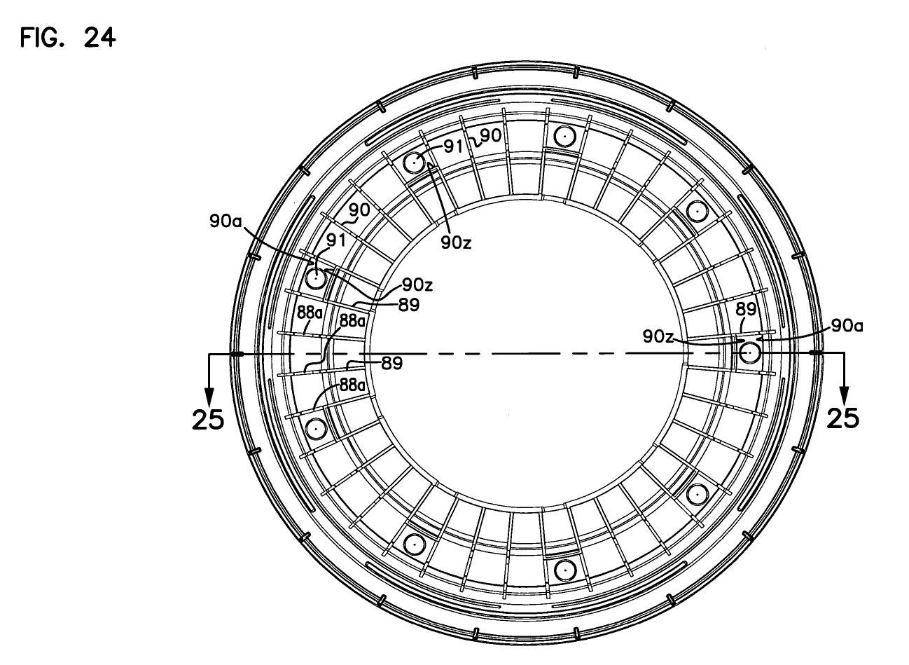

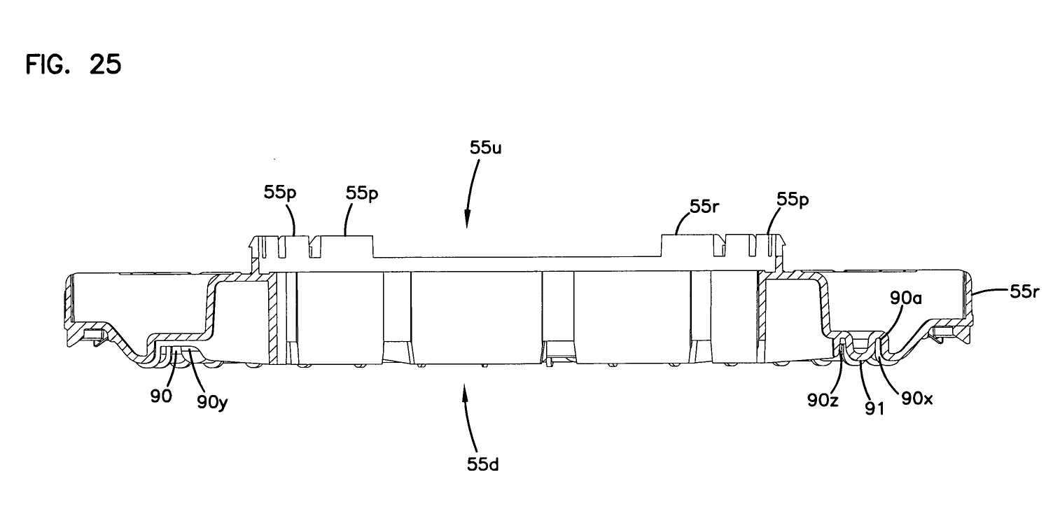

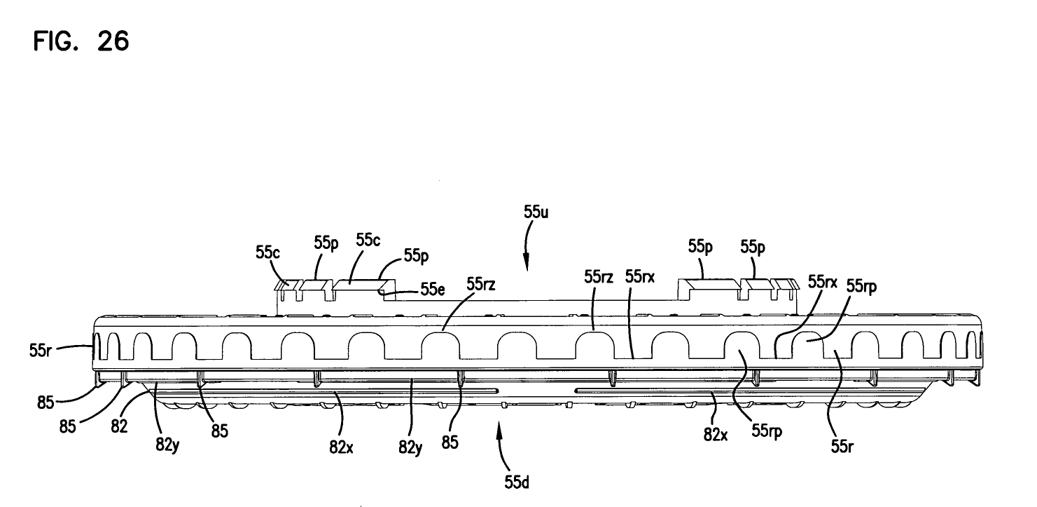

Attention is now directed to FIGS. 22-26. In FIG. 22, a bottom perspective view of the seal plate 55 is shown. In FIG. 23 a top plan view is shown. In FIG. 24 a bottom plan view is shown. In FIG. 25 a cross-sectional view taken along line 25-25, FIG. 24, and depicting the seal plate is normal operating orientation with an upper surface 55a directed up and a lower surface 55d directed down in shown. Finally in FIG. 26, a side elevational view is depicted.

Attention is directed to FIG. 26. Individual projections 55p projecting upwardly from a portion of flange 55 are viewable. Each projection 55p is configured for a snap fit to flange 69, FIG. 15, by having an upper cam surface 55c and a lower indent 55e. The projections 55p are spaced from one another, and configured to be flexible to facilitate the snap fit.

Still referring to FIG. 26, along outer rim 55r a plurality of spaced outwardly extending projections 55rp are shown, forming recesses 55rx therebetween and regions 55rz thereabove. Adhesive can settle around projections 55rp during installation, to facilitate installation.

Still referring to FIG. 26, depending downwardly and inwardly is outer seal compression region or surface 82 with circular projection members beads or projections 82x, 82y thereon. Surface 82 and first and second projections 82x, 82y are oriented and configured to press into pinch seal ring 60 during installation. This forms a housing seal, as shown in FIGS. 4, 5, 15 and 16. In general, surface 82 extends downwardly and extends radially inwardly in extension toward bottom surface 55d and away from top surface 55u. This provides a surface to pinch seal member 60, during installation. Projections 82y, 82x, are pushed further into pinch seal, during installation.

In some applications only a first one of circular projection beads 82x, 82y will be present. Also, alternate numbers from one and two projections are possible. Indeed, in some applications there may be no circular projection beads.

Outer rim 55r includes depending downwardly therefrom, and spaced radially around a portion of surface 82, spaced projections 85. The projections 85 operate to help ensure the seal plate 55 (and inlet stack 25) are in a proper snap fit condition with a remainder of inlet/access service cover assembly 6, when assembly 6 is constructed.

Attention is now directed to FIGS. 22 and 24. In FIG. 22, region 82 with seal projections 82x and 82y thereon, is also viewable. It is noted that seal projections 82x comprise spaced sections of a first segmented bead or ring 86; and, sections 82y comprise spaced sections of a second segmented bead or ring 87. The beads or rings 86, 87 are radially spaced from one another. The segments 82y are oriented to radially overlap the plurality of gaps 82g between segments 82x in segmented ring 86; and, segments 82x are oriented to radially overlap the plurality of gaps 83g in segmented ring 87. It is noted that the rings 86, 87, could in some instances be continuous. However segmented rings are typically used. A number of segments is a matter of choice, usually the number of segments in each ring 86, 87 will be at least two (2) and not more than eight (8).

When seal projections 82x, 82y are pushed into pinch seal member 60 during sealing, they will provide a point contact to inhibit the seal member 60 from pulling out of position, during installation; and, to help ensure a preferred seal.

Referring to FIG. 21, plate region 55z includes a plurality of upwardly directed spaced fins 88, for strength. In FIG. 22, downwardly directed fins 89 can be seen to have upwardly recessed portions 89a therein; each being unshaped and aligned to form a receiver channel or circular receiver trough 90 at a selected location between hub 55x and seal surface region 82, and around hub 55x. Channel 90 is positioned to overlap and receive axial projection 77, FIG. 5, during installation.

A cross-sectional view depicting this engagement, is shown in FIG. 16, an enlarged fragmentary view of a portion of FIG. 5. It is noted that in FIG. 16 end cap 35, including pinch seal flange 60 is shown in overlap with portions of seal plate 55. This shows the undistorted condition of flange 60, and from the figure the amount of compression of pinch seal flange 60 that will occur during ordinary installation can be understood. In FIG. 16, receipt of axial projection 77 into channel 90 during installation, can be seen.

Referring again to FIG. 22, the lower fins 89, then, form panel 90, at recess portions 86. Surrounding recess portions 86, each fin 89 forms a rib definition extending into recess 86, across recess 86, and then downwardly from recess 86. These ribs, an example being indicated at 86a having sides 86b, 86c and center 86d, FIG. 22, will engage projection 77 on cartridge 3, during installation. By pressing into the projection 77, the ribs 86a facilitate and secure a position in cartridge 3.

Also referring to FIG. 22, within channel 90 are positioned radially spaced, downwardly extending, compression projections or buttons 91. For the example shown there are eight (8) evenly radially spaced downwardly projecting compression projections or buttons 91, centrally located within channel 90. The specific number of projections 91 is a matter of choice. Typically there will be at least four and not more than 12 projections 91, and the projections 91 that are present, will typically be radially evenly spaced.

Referring to FIG. 22, it is noted that the projections 91 are positioned between selected ones of the fins 89, i.e., between selected ones of the ribs 86a.

The projections 91 are sized and configured to press into axial projection 77 on cartridge 3, during installation. This engagement is shown in FIG. 15, a fragmentary, enlarged, cross-sectional view depicting a portion of FIG. 4. It is noted that in FIG. 15, the projection 91 is drawn in overlap with axial projection 77 on end cap 35. The amount of overlap is intended to show the amount of interference or compression of projection 91 into projection 77 which will occur, during installation.

Each projection 91 is typically sized to project into projection 77 (i.e., to distort projection 77 through compression) an amount typically corresponding to at least 4 mm of compression, typically at least 5 mm of compression and usually an amount of compression within the range of 5 mm to 10 mm, inclusive. This will typically account for a compression in the thickness of projection 77, along inner rim 77i, FIG. 7, a distance of at least 40% usually at least 50% and typically 50% to 95%. In the context of this paragraph the “thickness” of projection 77, is meant to be a thickness as measured along a radially inner portion 77i, in projection outwardly from adjoining surface portion 35o, FIG. 17, of end cap 35.

In terms of the overall thickness of the end cap at region 77, in extension away from the upper end 30t the media pack 30, FIG. 17, projection 77 is usually on the order of at least 10 mm, not more than 30 mm, and typically 12-25 mm; and, the compression of projection 91 into the end cap 35 at this location, would generally extend a percent, relative to the total thickness of end cap 35 in this region, an amount corresponding to at least 20%, typically at least 25% and usually an amount within the range of 30%-70%, inclusive of this thickness.

Referring now to FIG. 25, for the example shown, in the portion of channel 90 where projections 91 are positioned, the channel 90 is narrowed somewhat, relative to portions 90y, in which the projections 91 are not located. In particular, referring to portion 90x, a radial inner side wall 90z is provided associated with projection 91.

Referring to FIG. 24, it can also be seen where projection 91 is located, channel 90 (associated with each projection 91) is provided with narrowed radial outer side wall 90a. Thus, receiver channel 90 includes narrowed sections where compression projections 91 are located.

Referring to FIG. 15, as projection 91 presses into projection 77, projection 77 will compress downwardly and expand (radially inwardly and outwardly). As projection 77 expands, it will engage radial inner surface or side wall 90z, and also radial outer surface or side wall 90a of channel 90. As a result of the expansion, projection 77, widening radially, will engage walls 90a, 90z (FIG. 25) of channel 90 forming a non-slip or interference fit together, for stabilization.

The described engagements between the seal plate assembly 55 and end cap 35 provide several effects. One is a housing seal arrangement 50 between the cartridge 3 and the housing 2. A second, is a seal between the seal plate 55 and the seal support 65. These two seals ensure that when unfiltered air enters the air cleaner, it does not bypass end cap 35 and enter annulus 40; rather the air is filtered by passage through cartridge 3 before entering annular 40. The previously described projections 82x, 82y, press down into pinch seal 60, and facilitate the sealing by ensuring that the seal 60 does not slip in position relative to surface 82 and seal support 65.

Under normal use conditions, as desirable to ensure that the cartridge 3 is secured rotationally, so that a tortional or tearing stress is not placed on the pinch seal 60 in a manner that could damage the seal 60 and the integrity of the cartridge 3. Inhibition of movement against twisting or other affects, is facilitated by the receipt of projection 77 into receiver channel 90. More specifically depression of buttons or projections 91 into axial projection 77, expands the axial projection 77 in a manner providing engagement with inner 90z and outer 90a side wall sections of the channel 90, for example as shown in FIG. 15, inhibiting relative rotation between the seal plate 55 and the cartridge 3. Also, ribs 86a pressing into projection 77 will facilitate stabilization of cartridge 3.

Referring to FIG. 6, it is noted that the central filter cartridge 3 is provided with a generally circular cross-sectional configuration, as well as a circular (outer perimeter) shaped seal lip 60. It is noted that certain of the principles described here can be applied with a variety of shapes of cartridges 3.

As discussed previously, a housing seal arrangement 49, FIG. 3, is also provided between the cartridge 3 and a lower portion of the housing base 5. With respect to this, attention is directed to FIG. 10.

Referring to FIG. 10, cartridge 3 includes end cap 36. End cap 36 is provided with an outer annular portion 95, which operates to provide a seal with a portion of housing 2. In particular, outer annular portion 95 of end cap 36 comprises a seal material, for example, compressible polyurethane foam. When inserted within lower portion 15 of housing 2, an outwardly directed radial seal can be provided against annular housing seal surface 96. The material of outer annular portion 95 may comprise an analogous polyurethane foam to that utilized for end cap 35. Of course alternate types of housing seals at end cap 36 can be used, in some instances.

Referring to FIG. 5, it is noted that end cap 36 generally has a circular outer perimeter shape for seal member 95, analogous to the perimeter shape for cartridge media pack 3, and end cap 35.

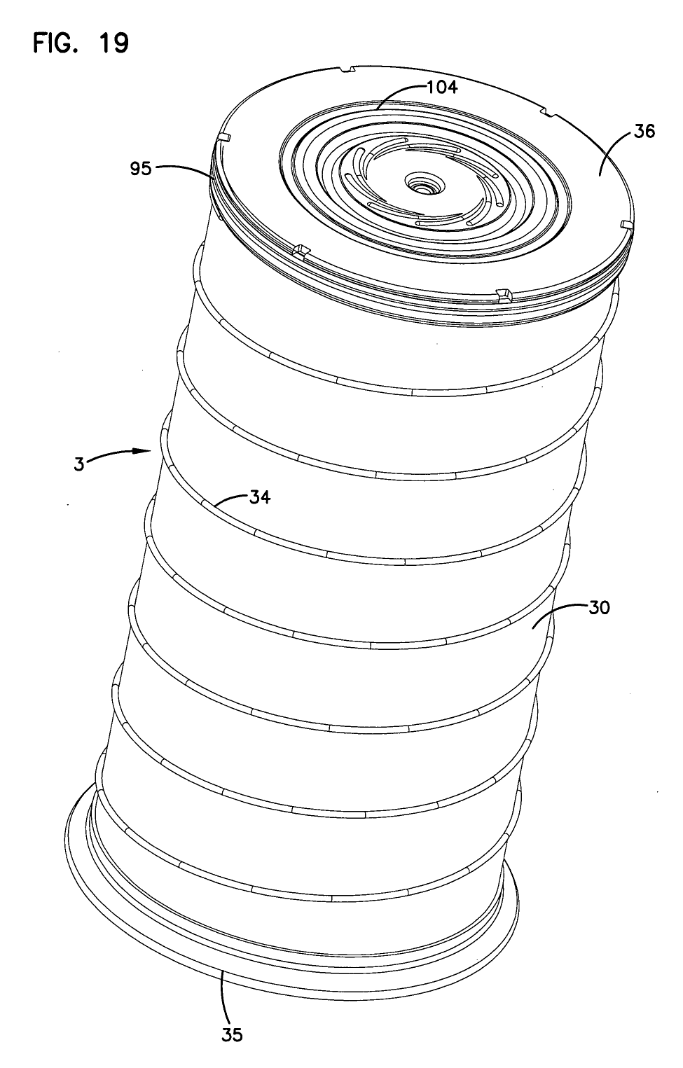

Attention is now directed to FIG. 19, a bottom perspective view of cartridge 3. Here the circular outer perimeter shape for seal region 95 of end cap 36 is readily inspected.

Attention is now directed to FIGS. 7 and 18, in which cartridge 3 is depicted in cross-section. Referring first to FIG. 7, attention is directed to end cap 36. For the example shown, end cap 36 comprises a composite end cap including preform insert 100 secured in place by mold-in-place end cap material 101. The insert 100 would generally comprise a preform, molded from a hard plastic such as a high impact polystyrene, although alternatives are possible. During assembly the preform 100 would be attached to media pack 3, and the end of the media pack 3 with the insert 100 thereon would be inserted into a mold in which is included a resin formulation for molded-in-place overmold 101. Still referring to FIG. 7, insert 100 includes a central flow direction surface portion 105 configured to direct liquid thereon, under gravity flow, toward drainage aperture arrangement 106. The drainage aperture arrangement 106 may comprise a single aperture or a plurality of apertures. Typically the total open or perimeter area of drainage aperture arrangement 106, in engagement with upper (inside) surface 36u of end cap 36 would be no greater than 5%, usually no more than 4% and typically 3% or less, of a total inside perimeter area defined by media pack 30. Herein the term “total inside perimeter area” when used in this context, is meant to refer to a cross-sectional area defined within region 3i by surrounding media pack 30. Alternately stated, it is a projected perimeter area defined in surface 36u by surrounding media pack 30.

Typically, the total inside perimeter (open) area of the drain aperture arrangement 106, whether a single aperture or multiple apertures, is no more than 2.0 sq. inch (13 sq. cm.), typically no more than 1.5 sq. inch (92 sq. cm.), and usually 0.5 sq. inch (3.2 sq. cm.) or less.

The drain aperture arrangement 106 comprises a portion along upper surface 36u with aperture or apertures therein. The area stated, relates to the size of the aperture(s) at the inner face with surface 36u. It is noted that on lower side 36l of end cap 36, aperture area can vary from that on surface 36u.

In more general terms, the total open area of the drainage aperture arrangement 106, is typically no more than 40% of a total inside perimeter area defined by the media pack 30; and, the total inside perimeter area of the drain aperture arrangement 106 is typically no more than about 10 sq. inches (64.5 sq. cm.). It is noted that alternatives are possible, but a relatively small size for the total open area of the drainage arrangement characterized, is typical, to help retain contaminant inside cartridge 3. Usually, the drain arrangement has an area of at least 0.1 sq. inch (0.6 sq. cm.), and typically at least 0.1% of the interior surface area.

In even more general terms, the open area of drainage aperture arrangement 106 is preferably smaller than an open area of aperture 39 in end cap 35 typically by at least 20% and usually at least 40%. Alternately stated, the total open area of drainage aperture arrangement 106 is preferably no more than 80% of the open area of aperture 39 and end cap 35, and typically no more than 60% of that area.

Referring to FIG. 7, insert 100 is generally provided with an upper surface 100u that directs liquid toward aperture arrangement 106, by having a surface slanted toward aperture arrangement 106. In addition, referring to FIG. 3, surface 100u typically includes free-rise apertures 100f therein, for rise of resin material forming region 101, during installation.

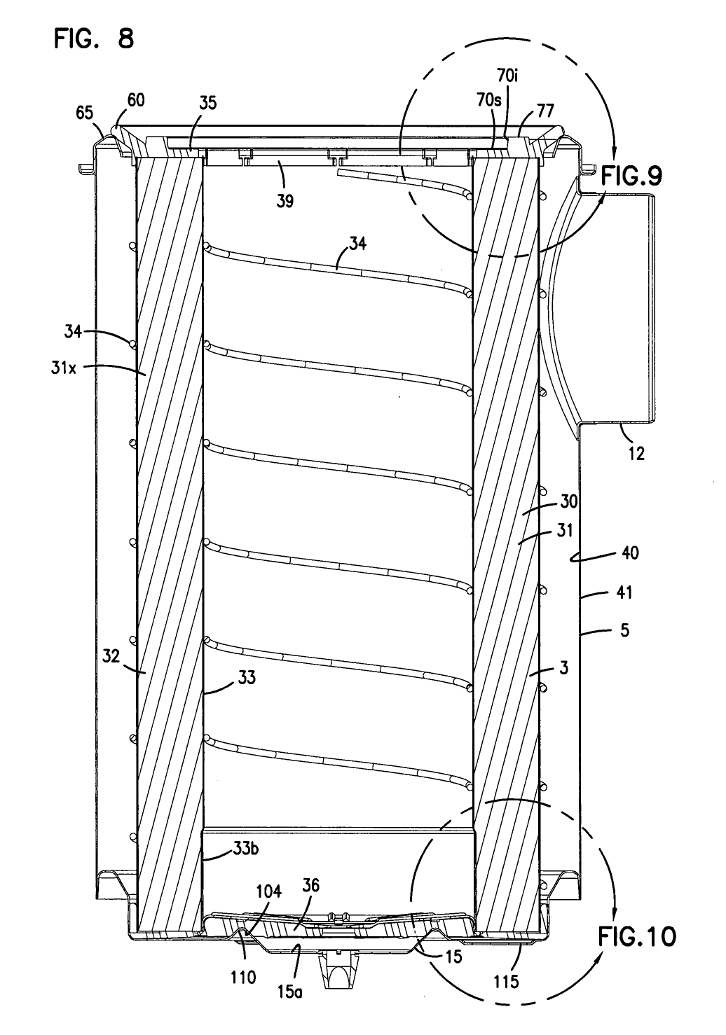

Referring to FIG. 7, molded-in-place material 101 is provided with a trough 109 in outer axial or surface 361. The trough 109 is generally circular, FIG. 19, and has a somewhat v-shaped cross-section within an apex (FIG. 7) at a deepest projection into end cap 36. The trough 109 is configured to receive, i.e., mate with, an upper projection 110 in housing bottom 15, see FIG. 8. This engagement inhibits movement of material from central region 15a of housing bottom 15, toward outer perimeter region 115. It is noted that in FIG. 8, bottom base portion 5 of the assembly 1 is depicted, with the cartridge 3 in place, but without the inlet/access service cover 6 (FIG. 1) in place.

The trough 109 is typically positioned at a location in axial overlap with interior 3i of cartridge 3 surrounded by media pack 30.

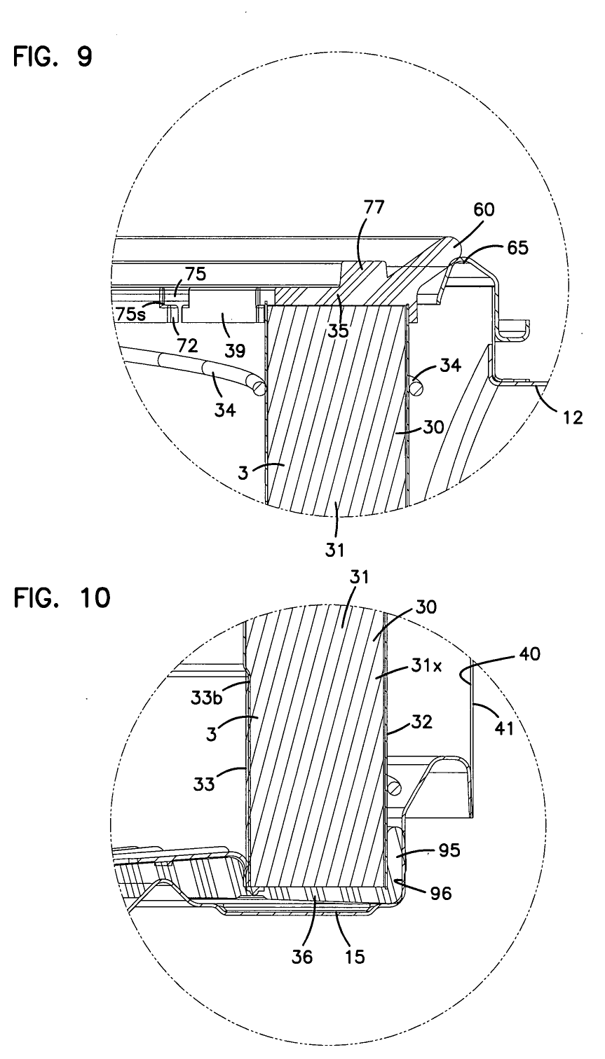

In FIG. 10, an enlarged fragmentary view of selected portions of FIG. 8 are depicted. In FIG. 9, an enlarged fragmentary view of selected portions of FIG. 8 are also depicted.

Referring to FIG. 18, an enlarged fragmentary view of a portion of FIG. 7, it is noted that annular region 95 includes a region 95x which will compress maximally, when cartridge 3 is installed in housing 5 against surface 96, FIG. 5.

In the figures, dimension lines are provided, for reference. The following dimensions corresponding to indicated reference lines in the figures as stated, are meant to identify an example arrangement. Other dimensions can be taken from scale: in FIG. 7, AA=356.5 mm; AB=266.8 mm; AC=218.85 mm; in FIG. 16, BA=8.8 mm; BC=9.5 mm; BD=16.37 mm; BE=9.52 mm; BF=4.76 mm radius; BH=5.0 mm radius; and BG=30.98 mm.

In general terms, in accord with the above descriptions an air filter cartridge is provided. The filter cartridge generally includes a media pack extending between first and second end caps. The first end cap includes a central air flow aperture and an outwardly directed pinch seal flange extending radially away from the media pack outer perimeter in a direction also away (axially) from the second end cap. The second end cap includes a housing seal portion thereon, and, drain arrangement therethrough. Although alternatives are possible, the media pack for the example shown generally defines a circular, or cylindrical, outer perimeter; and, the pinch seal flange generally defines a circular outer perimeter.

Although alternatives are possible, for the particular example arrangement described the housing seal portion of the second end cap comprises an outwardly directed radial seal portion.

In the example described, first end cap includes an axial end portion, an axial overlap with the media pack. The outwardly directed pinch seal flange extends outwardly from the axial end portion a direction away from the central air flow aperture. The axial end portion includes an axial projection ring thereon: projecting away from the media pack; an axial overlap with the media pack; surrounding and spaced from the central air flow aperture; and, surrounded by the outwardly directed pinch seal flange. In the example shown, the axial projection ring is adjacent the outwardly directed pinch seal flange.

As described, the axial projection ring can be a discontinuous, or continuous ring. In the example depicted, a continuous ring is shown.

The axial projection ring has a first end surface, remote from the media pack, with a radial width typically of at least 8 mm and not more than 25 mm. The axial projection ring also has an inner edge with a height, adjacent the inner edge, from an immediately adjacent portion of the end cap within the range of 5 mm to 15 mm, inclusive. Also, the axial projection typically has a thickness, in extension axially outwardly from the media pack, of at least 10 mm and not more than 30 mm.

Typically, the pinch seal flange has opposite side walls spaced at least 5 mm and not more than 20 mm apart from one another. Also typically the pinch seal flange extends away from the media pack in an obtuse angle x thereto, the angle x being at least 110° and not more than 70°, and typically 115°-160°.

The pinch seal flange on the first end cap typically comprises a molded-in-place polyurethane foam.

The housing seal arrangement of the second end cap, although alternatives are possible, typically includes an outwardly directed radial seal member comprising molded-in-place polyurethane. Also typically the second end cap has a circular outer perimeter shape.

In an example described, the second end caps include an outer axial surface with a circular trough therein. The circular through is positioned in axial overlap with an interior region surrounded by the media pack.

Typically the second end cap comprises a preform secured in place with molded-in-place end cap material, although alternatives are possible. The molded-in-place end cap material of the second end cap typically comprises polyurethane foam.

When the second end cap comprises a preform secured in place with molded end cap material, the preform typically includes an inner surface portion surrounded by the media pack, the inner end cap surface portion including a flow directing surface configured to direct liquid thereto to a drain arrangement therein or therethrough. The drain arrangement can comprise a single aperture or plurality of apertures.

A typical preform defines an inner end cap region having free rise apertures therethrough, the inner end cap region being surrounded by the media pack.

A variety of media types can be utilized with arrangements according to the present disclosure. An example shown and described, the media pack comprises pleated media oriented with inner and outer pleat tips and extending between first and second end caps. Also in described arrangement, the media pack includes inner and outer media support liners, in the example described each liner being the expanded metal liner.

According to the present disclosure, an air cleaner assembly is described. The air cleaner assembly comprises a housing defining a housing interior and including an inlet/access (service) cover assembly and a housing base. The inlet/access (service) cover assembly is removably mounted on the housing base and including a sealing plate thereon. The base includes a seal support thereon.

In general, a filter cartridge is positioned within the housing with a pinch seal flange thereof compressed between the sealing plate and the seal support; and, with the housing seal portion at an opposite end of the pinched cartridge from the pinch seal flange, sealed to the housing base.

In an example described, the seal plate includes an outer seal compression surface which tapers radially inwardly in extension downwardly, during installation. The seal compression surface includes a first circular projection bead thereon, and the seal plate is positioned with the seal compression surface directed downwardly and radially outwardly into the pinch seal flange and with the first circular projection bead directed into the pinch seal flange.

In an example shown, the seal compression includes first and second radially spaced circular projection beads thereon, each of which is directed in the pinch seal flange. In an example shown, both first circular compression bead and the second circular compression bead comprise segmented rings.

In an example described, the segmented rings are oriented such that gaps in one are overlapped immediately by gaps in the other, and vice versa.

In an example shown, a first end cap of the cartridge includes an axial projection ring projecting away from the media pack, and axial overlap with the media pack. The seal plate includes a lower surface with a receiver channel therein, into which the axial projection ring of the first end cap projects.

In an example, the receiver channel includes a plurality of spaced compression projections therein, organized to press into the axial projection ring during installation. The channel, at the locations of the spaced projections, narrowed by inner and outer rims, so that during the projection, as the axial projection ring is compressed in thickness it widens, and presses against the channel for secure engagement.

In an example described, the seal plate has a lower surface including a plurality of fins therein. The fins are spaced, and the receiver channel is in part defined by the fins. Where the fins engage the receiver channel, each fin defines a rib configured to engage the seal projection on the cartridge, to facilitate securement. The ribs generally form inverted unshaped pocket, with an upper surface, an outer surface, and an inner surface.

It is noted that the principles of the present disclosure can be provided in a variety of arrangements, including ones with alternate dimensions and configurations. Further, many features have been described and illustrated with specificity. There is no requirement that an arrangement include all of the features characterized herein, to provide for some advantage according to the present disclosure.

1-36. (canceled)

1. An air filter cartridge comprising:
(a) a media pack extending between first and second end caps;
(i) the first end cap including a central air flow aperture and an outwardly directed pinch seal flange extending radially away from the media pack;
(ii) the second end cap including: a housing radial seal portion thereon; and, a drain arrangement therethrough.

2. An air filter cartridge according to claim 1 wherein:
(a) the pinch seal flange also extends in a direction away from the second end cap.

3. An air filter cartridge according to claim 1 wherein:
(a) the media pack defines a circular outer perimeter.

4. An air filter cartridge according to claim 1 wherein:
(a) the housing seal portion of the second end cap includes an outwardly directed radial seal portion.

5. An air filter cartridge according to claim 1 wherein:
(a) the first end cap includes an axial end portion in axial overlap with the media pack;
(i) the outwardly directed pinch seal flange extending outwardly from the axial end portion in a direction away from the central air flow aperture; and,
(ii) the axial end portion including an axial ring projection thereon: projecting away from the media pack; in axial overlap with the media pack;
surrounding and spaced from the central air flow aperture; and,
surrounded by the outwardly directed pinch seal flange.

6. An air filter cartridge according to claim 5 wherein:
(a) the axial ring projection is a continuous ring.

7. An air filter cartridge according claim 5 wherein:
(a) the axial projection ring has a first outer axial end surface, remote from the media pack, with a radial width of at least 8 mm and not more than 25 mm.

8. An air filter cartridge according to claim 5 wherein:
(a) the axial projection ring has a radially inner edge and a height, adjacent the radial inner edge, from an immediately adjacent portion of the first end cap within the range of 5 mm to 15 mm, inclusive.

9. An air filter cartridge according to claim 5 wherein:
(a) the axial projection ring comprises a portion of the first end cap having an overall axial thickness, from the media pack, of at least 10 mm and not more than 30 mm.

10. An air filter cartridge according to claim 1 wherein:
(a) the pinch seal flange has opposite side walls spaced apart a distance within the range of 5-20 mm, inclusive.

11. An air filter cartridge according to claim 1 wherein:
(a) the pinch seal flange extends away from the media pack at an obtuse angle x thereto;
(i) the obtuse angle x being at least 110° and not more than 170°.

12. An air filter cartridge according to claim 11 wherein:
(a) the obtuse angle x is within the range of 115°-160°, inclusive.

13. An air filter cartridge according to claim 11 wherein:
(a) the pinch seal flange on the first end cap comprises a molded-in-place polyurethane foam.

14. An air filter cartridge according to claim 1 wherein:
(a) the second end cap comprises a preform insert secured in place with molded-in-place end cap material.

15. An air cleaner assembly comprising:
(a) a housing defining a housing interior and including an inlet/access cover assembly and a housing base;
(i) the inlet/access cover assembly being removably mounted on the housing base;
(ii) the inlet/access cover assembly including a seal plate; and,
(iii) the base including a seal support thereon;
(b) an air filter cartridge in accord with claim 1 positioned within the housing interior with:
(i) the pinch seal flange compressed between the seal plate and the seal support; and,
(ii) the housing seal portion of the second end cap sealed to the housing base.

16. An air cleaner assembly according to claim 15 wherein:
(a) the seal plate includes an outer seal compression surface;
(i) the seal compression surface including a first circular projection bead thereon;
(ii) the seal plate being positioned with the seal compression surface directed downwardly and radially outwardly into the pinch seal flange and with the first circular projection bead directed into the pinch seal flange.

17. An air cleaner assembly according to claim 16 wherein:
(a) the seal compression surface includes first and second, radially spaced, circular projection beads thereon;
(i) the seal plate being positioned with the first and second circular projection beads directed into the pinch seal flange.

18. An air cleaner assembly according to claim 17 wherein:
(a) the first circular compression bead comprises a segmented ring; and,
(b) the second circular compression bead comprises a segmented ring.

19. An air cleaner assembly according to claim 18 wherein:
(a) the first, segmented, circular compression bead includes a plurality of gaps therein, between segments thereof; and,
(b) the second, segmented, circular compression bead includes a plurality of gaps therein, between segments thereof;
(i) each gap in the first, segmented, circular compression bead being radially overlapped by a selected one of the segments in the second, segmented, circular compression bead; and
(ii) each gap in the second, segmented, circular compression bead being radially overlapped by a selected one of the segments in the first, segmented, circular compression ring.

20. An air cleaner assembly according to claim 15 wherein:
(a) the first end cap of the cartridge includes an axial projection ring: projecting away from the media pack; in axial overlap with the media pack; surrounding and spaced from the central air flow aperture of the cartridge; and, surrounded by the outwardly directed pinch seal flange; and,
(b) the seal plate includes a lower surface with a receiver channel therein, into which the axial projection ring of the first end cap projects.

21. An air cleaner assembly according to claim 20 wherein:
(a) the receiver channel of the seal plate includes a plurality of compression projections therein each of which is pressed into the axial projection ring.

22. An air cleaner assembly according to claim 21 wherein:
(a) each compression projection in the receiver channel compresses an adjacent portion of the axial ring by at least 4 mm.

23. (canceled)

24. An air cleaner assembly according to claim 21 wherein:
(a) each compression projection in the receiver channel is positioned in a narrowed receiver channel portion with a radial inner wall and a radial outer wall;
(i) the axial projection ring being expanded into contact with the radial inner and radial outer walls within each narrowed channel portion, upon compression by an associated one of the compression projections.

25. An air cleaner assembly according to claim 20 wherein:
(a) the axial projection ring is a continuous ring.

26. (canceled)

27. An air cleaner assembly according to claim 20 wherein:
(a) the seal plate lower surface comprises a plurality of spaced fins; each fin defining a rib pressed into the axial projection ring
